(19) United States
(12) Patent Application Publication
(10) Pub. No.: US 2026/0100055 A1
(43) Pub. Date: Apr. 9, 2026

(54) SYSTEMS AND METHODS FOR DETECTING TRAFFIC LIGHT VIOLATIONS

(71) Applicant: Verizon Patent and Licensing Inc, Basking Ridge, NJ (US)

(72) Inventors: Tomaso TRINCI, Florence (IT); Tommaso BIANCONCINI, Florence (IT); Leonardo TACCARI, Florence (IT); Francesco SAMBO, Florence (IT); Leonardo SARTI, Florence (IT); Simone MAGISTRI, Florence (IT)

(73) Assignee: Verizon Patent and Licensing Inc., Basking Ridge, NJ (US)

(21) Appl. No.: 18/907,984

(22) Filed: Oct. 7, 2024

Related U.S. Application Data
(63) Continuation-in-part of application No. 18/749,945, filed on Jun. 21, 2024.

(51) Int. Cl. G06V 20/58; B60Q 9/00; G06V 10/764; G06V 10/77; G06V 10/82; G08G 1/01

(52) U.S. Cl. CPC G06V 20/584; B60Q 9/00; G06V 10/764; G06V 10/7715; G06V 10/82; G08G 1/0133

(57) ABSTRACT

In some implementations, a computing device may identify an image captured of a driving scene associated with a vehicle. The computing device may create a feature map based on the image. The computing device may detect a traffic light associated with the image using an object detector. The computing device may predict a relevance attribute of the traffic light using a relevance classifier. The computing device may predict a state attribute of the traffic light using a state classifier. The computing device may create an enhanced feature map based on the feature map and an output of the object detector. The computing device may generate an image-level recommendation using an image-level classifier, wherein the image-level recommendation is based on the enhanced feature map being provided as an input to the image-level classifier.

### CROSS-REFERENCE TO RELATED APPLICATION

This patent application is a Continuation-In-Part patent application and claims priority to U.S. patent application Ser. No. 18/749,945, filed on Jun. 21, 2024, and entitled “SYSTEMS AND METHODS FOR DETECTING TRAFFIC LIGHT VIOLATIONS.” The disclosure of the prior application is considered part of and is incorporated by reference into this patent application.

### BACKGROUND

Traffic laws may govern and regulate vehicles on roadways. Traffic laws may define rules involving observing speed limits, observing traffic lights, following traffic signs, yielding to special vehicles (e.g., school buses and emergency vehicles), etc. Individuals that violate traffic laws may be subjected to fines or other types of punishment.

### BRIEF DESCRIPTION OF THE DRAWINGS

FIG. 1 is a diagram of an example associated with detecting traffic light violations.

FIG. 2 is a diagram of an example associated with object detection.

FIG. 3 is a diagram of an example associated with turn detection.

FIG. 4 is a diagram of an example associated with speed detection.

FIG. 5 is a diagram of an example associated with traffic light state classification.

FIG. 6 is a diagram of an example associated with an intersection.

FIG. 7 is a diagram of an example associated with relevant traffic light sequences in a video.

FIG. 8 is a diagram of an example associated with identifying relevant traffic lights in driving scenes.

FIG. 9 is a diagram of an example associated with identifying relevant traffic lights in driving scenes.

FIG. 10 is a diagram of an example associated with identifying relevant traffic lights in driving scenes.

FIG. 11 is a diagram of an example associated with identifying relevant traffic lights in driving scenes.

FIG. 12 is a diagram of an example environment in which systems and/or methods described herein may be implemented.

FIG. 13 is a diagram of example components of one or more devices of FIG. 12.

FIG. 14 is a flowchart of an example process associated with detecting traffic light violations.

FIG. 15 is a flowchart of an example process associated with identifying relevant traffic lights in driving scenes.

### DETAILED DESCRIPTION OF EXAMPLE EMBODIMENTS

The following detailed description of example implementations refers to the accompanying drawings. The same reference numbers in different drawings may identify the same or similar elements.

### Detecting Traffic Light Violations

A camera may be installed on a dashboard of a vehicle and capture video of the road when the vehicle is driving on the road. The vehicle may be a connected vehicle. The camera may be an onboard camera, mounted on the dashboard, that records a scene associated with the vehicle. The camera may start capturing video after the vehicle is turned on and may stop capturing video after the vehicle is turned off. When the camera detects an event (e.g., hard acceleration or harsh cornering), a video recording from the captured video may be created. The video recording may include video of the road and surrounding areas associated with the event. For example, the video recording may include objects near the vehicle, such as stop signs, traffic lights, and/or surrounding vehicles. The camera may send the video recording to a server. The server may review the video recording, and based on the video recording, the server may classify the event using a video detection algorithm. For example, the server may classify the event as being related to an unsafe driving behavior. Alternatively, the classification of the event may be performed by a local computing device associated with the vehicle. A notification may be sent to a driver of the vehicle and/or a supervisor. Depending on the video recording and the classification of the event, the driver may be coached in safter driving habits.

In one example, the event may be a red traffic light violation. The red traffic light violation may occur when the vehicle crosses an intersection after a traffic light controlling the intersection has turned red. In other words, the red traffic light violation may occur when the vehicle enters the intersection (e.g., passes a stop bar) after the traffic light has turned red. A detection of the red traffic light violation may involve determining a state of the traffic light in the scene, determining which traffic light is relevant to the vehicle, and/or determining whether the vehicle is crossing the relevant traffic light when the state of the traffic light is red.

However, detecting red traffic light violations in video recordings obtained from connected vehicles may be difficult, and in some cases, red traffic light violations may be mistakenly detected or not detected altogether. Traffic light relevance may be one cause of misdetections for red traffic light violations or non-detections of traffic light violations. In a scene captured from the intersection in which the traffic light regulates the passage of vehicles, dozens of traffic lights may be turned on at the same time and with different colors. For example, some traffic lights may be red, other traffic lights may be yellow, and still other traffic lights may be green. A determination as to which traffic light regulates a passage for a given vehicle (and corresponding driver) may be challenging. Such a traffic light may be considered to be a relevant traffic light. In the scene, zero, one, or more traffic lights may be considered to be relevant traffic lights. In some cases, especially with multiple lanes, determining which traffic light is relevant to a particular vehicle may be difficult.

As an example, in a scene, the only relevant traffic light out of multiple traffic lights may be a traffic light in the middle of the scene, as a traffic light in a left portion of the scene may be regulating just a left turn and a traffic light in a right portion of the scene may be regulating a crossing for pedestrians. In another example, in a scene, one traffic light may be considered to be relevant when the vehicle is performing a right turn. In this case, the relevant traffic light may not be aligned with a center of the scene, so knowledge of a context of the vehicle's movement (e.g., performing the right turn) may be needed to determine which traffic light is relevant. In these examples, detecting which traffic light is relevant to the vehicle may be challenging.

As an example, in a scene, a traffic light on a highway ramp may turn green just for a few seconds, which may indicate that a single vehicle is able to pass. When the vehicle is actually passing the traffic light, a state of the traffic light may already be red again. As another example, in a scene, a traffic light may be red, but the vehicle may lawfully make a right turn when the traffic light is red. In this example, such an event should not be classified as a traffic light violation, even though the traffic light is red when the vehicle makes the right turn. As yet another example, a traffic light may flash red or yellow (depending on different meanings), and generally a vehicle may be permitted to cross an intersection in such a scenario, which may happen more frequently at night. In these examples, the vehicle may legally cross a relevant traffic light while the traffic light's state is red, which may mistakenly trigger a traffic light violation to be detected.

In some implementations, an anti-causal algorithm, using speed and video, may combine deep learning models with heuristics to accurately detect traffic light violations in videos obtained from connected vehicles. The detection of traffic light violations may be without the usage of high-definition satellite map information. The detection of traffic light violations may be part of a fleet management application. The detection of traffic light violations may be relatively accurate, even in the presence of multiple traffic lights and even when the vehicle performs a special case (e.g., making a right turn on a red light). The detection of traffic light violations may be used to identify coachable events, so that drivers in a commercial fleet may improve their behavior and increase overall safety.

In some implementations, by combining speed information, video information, deep learning models, and/or heuristics, video obtained from a connected vehicle may be analyzed to accurately detect traffic light violations. Video captured by a camera onboard the vehicle may be analyzed to determine whether the vehicle unlawfully crosses an intersection when the traffic light is red. The anti-causal algorithm may be able to account for corner cases, such as traffic lights on highway ramps that are green for only a short period of time, lawfully permitted right turns by vehicles even when the traffic light is red, and/or traffic lights that flash red or yellow during which the vehicle is permitted to cross the intersection. Such corner cases may be considered and may not unnecessarily result in false traffic light violation predictions. As a result, an ability to accurately predict whether traffic light violations occur may be achieved, thereby improving an overall system performance.

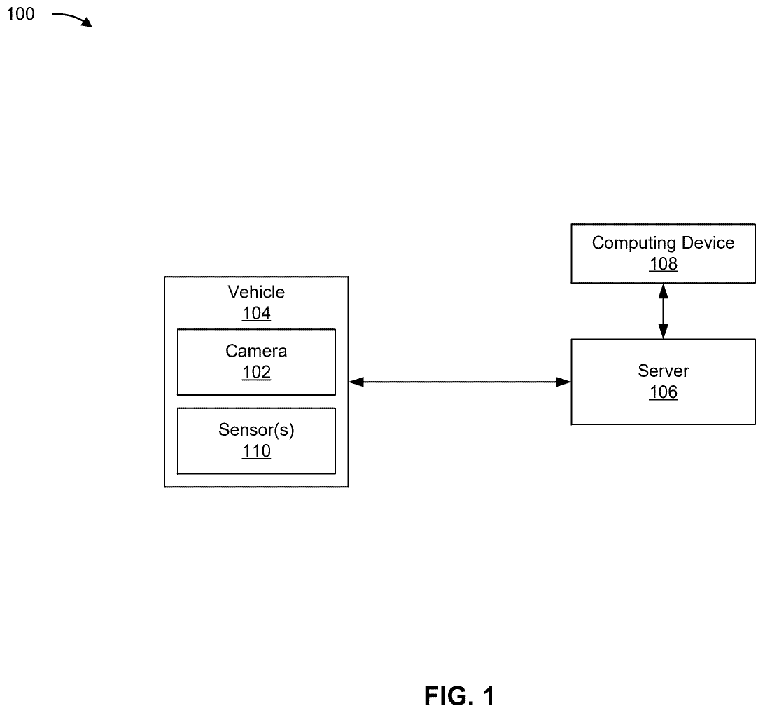

FIG. 1 is a diagram of an example 100 associated with detecting traffic light violations. As shown in FIG. 1, example 100 includes a camera 102, a vehicle 104, a server 106, a computing device 108, and sensor(s) 110. The camera 102 may be onboard the vehicle 104. For example, the camera 102 may be installed on a dashboard of the vehicle 104.

The camera 102 may capture a video recording of a scene surrounding the vehicle 104. The camera 102 may be able to record video of the scene that is in front of the vehicle. For example, the camera 102 may be able to record objects and pedestrians that are in front of the vehicle. The camera 102 may be continuously recording the scene when the vehicle is turned on.

One or more sensors 110 may capture sensor information. The one or more sensors 110 may include a gyroscope. The gyroscope may be integrated with the camera 102, or the gyroscope may be external to the camera 102. In this example, the sensor information may include rotation information, orientation information, and/or angular velocity information associated with the vehicle 104. The one or more sensors 110 may include a global positioning system (GPS). In this example, the sensor information may include speed information associated with the vehicle 104.

The camera 102 (or another computing device associated with the vehicle 104) may transmit the video recording and the sensor information to the server 106, where the server 106 may detect a traffic light violation based on the video recording and the sensor information. Alternatively, the video recording and the sensor information may be processed locally by the computing device associated with the vehicle 104. In this example, a traffic light violation detection may be performed locally at the vehicle 104. The server 106 may obtain the video recording and the sensor information, where the video recording may be of the scene captured by the camera 102 onboard the vehicle 104, and the sensor information may be associated with the vehicle 104 (e.g., orientation information and/or speed information).

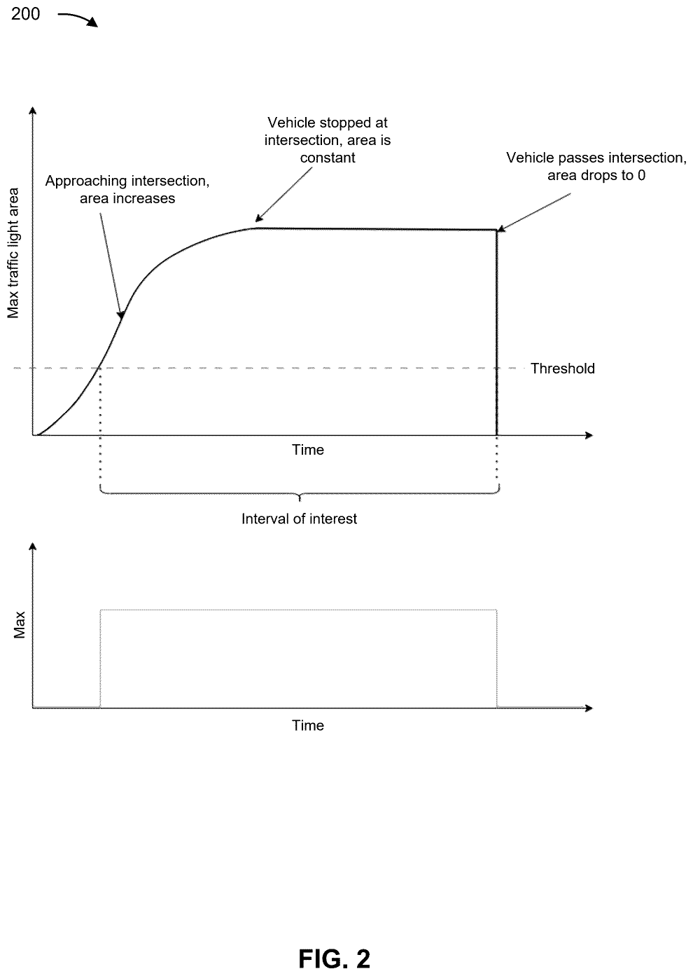

The server 106 may perform an object detection (OD) that indicates a presence of a traffic light in a frame of the video recording. The object detection is described in greater detail in FIG. 2. The object detection may not necessarily detect which traffic light of multiple traffic lights is relevant in the frame. Rather, the object detection may be used to determine whether one or more traffic lights are present in the frame, and which color(s) are associated with the traffic lights. A red traffic light may indicate that the vehicle 104 is to stop at an intersection, a yellow traffic light may indicate that the vehicle 104 is to slow down and stop at the intersection if possible, and a green traffic light may indicate that the vehicle 104 is allowed to pass the intersection without stopping.

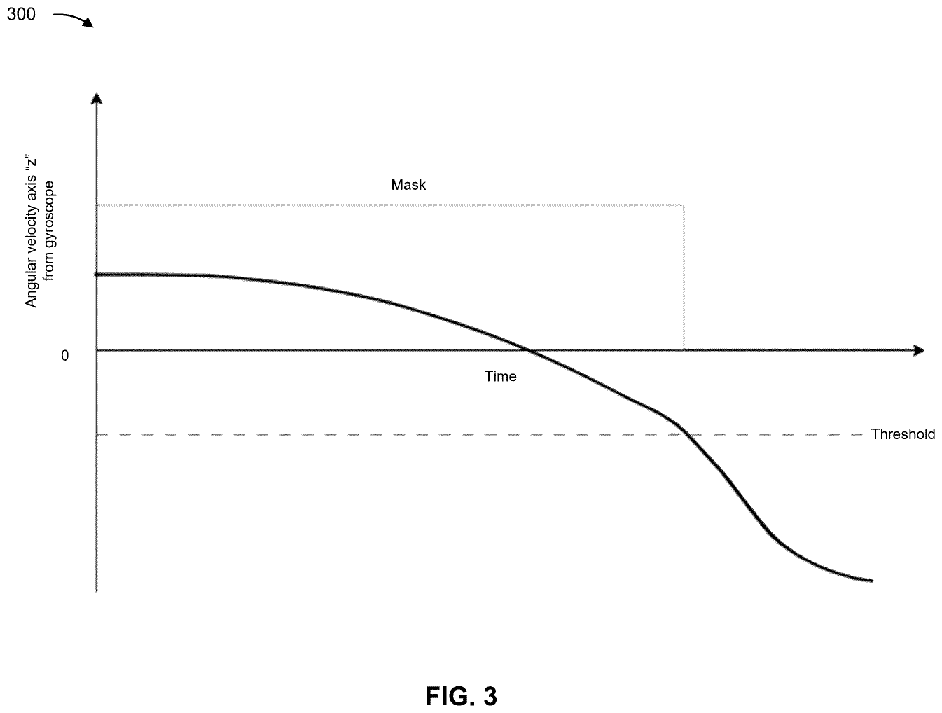

The server 106 may perform, based on the sensor information, a turn detection (RT) that indicates whether the vehicle 104 is performing a turn during the frame. The turn detection is described in greater detail in FIG. 3. For example, the turn detection may be used to detect whether the vehicle 104 is performing a right turn on the intersection. A right turn detection may be useful because, in some cases, the vehicle 104 may be permitted to make the right turn even when the traffic light is red. In other words, such an action may not constitute a traffic signal violation. The server 106 may determine whether the vehicle 104 is making the right turn based on gyroscope information.

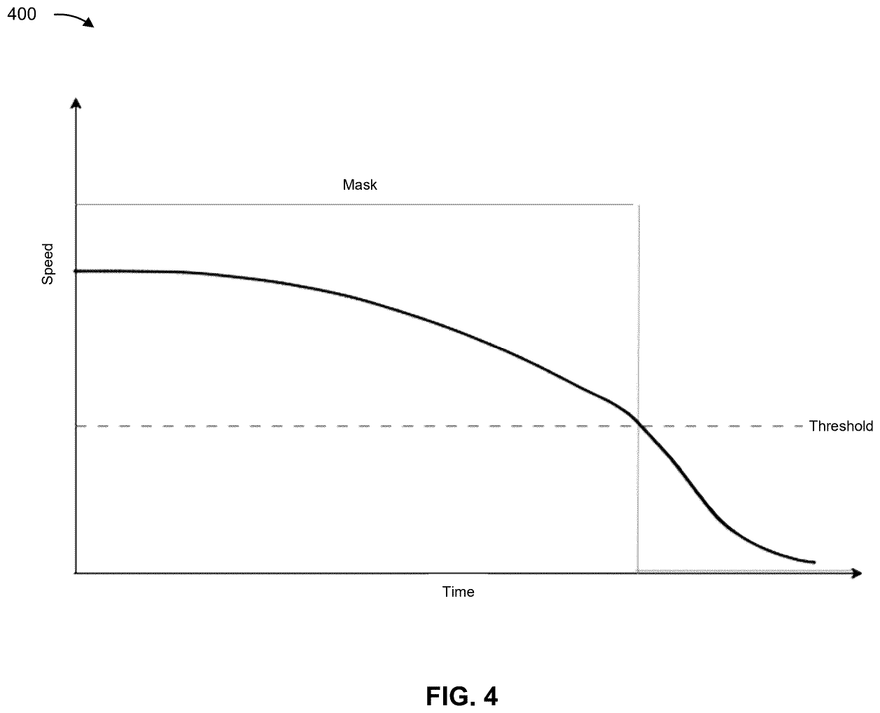

The server 106 may perform, based on the sensor information, a speed detection (S) that indicates a speed associated with the vehicle 104 during the frame. The speed detection is described in greater detail in FIG. 4. The vehicle 104 may include a GPS that tracks a speed of the vehicle 104 in real-time. The server 106 may correlate a timestamp associated with the frame and a timestamp associated with the speed of the vehicle 104, such that the server 106 may be able to determine, when the frame was taken, the speed of the vehicle 104 at that time.

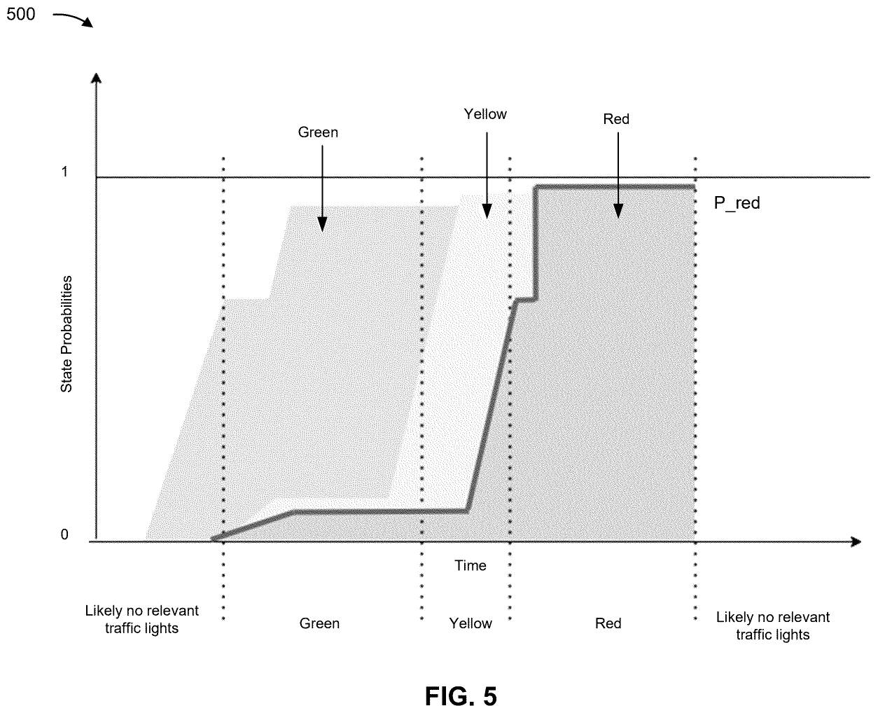

The server 106 may determine, based on an image classifier, a red light probability (P_{red}) that the frame contains at least one relevant red traffic light for the vehicle 104. The red light probability is described in greater detail in FIG. 5. The image classifier may be used to categorize road images captured by the camera. The image classifier may be fed with additional inputs other than an image, such as the results of on an object detector with multiple attributes, and the multiple attributes may include a first attribute for traffic light relevance and a second attribute for traffic light state. The image classifier may be trained using a training set, where the training set may include a plurality of historical images. As a result, the server 106 may determine, for the frame, a probability that a particular red light is relevant to the vehicle 104.

The server 106 may calculate a violation score based on the object detection, the turn detection, and the red light probability with respect to the frame, and based on the speed detection. The violation score may account for, based on a grace period, a traffic light that turns green for a limited time period that allows only a single vehicle to pass and then turns red. The violation score may account for the vehicle making a lawfully permitted right turn when the traffic light is red. The frame may be one of multiple frames, and the violation score may account for the traffic light flashing red or flashing yellow based on the multiple frames. The violation score may be a numerical value, and the violation score may fall within a defined range (e.g., 0 to 1, or 0 to 100). The violation score may be computed using different components, which may be related to the object detection, the turn detection, the red light probability, and/or the speed detection.

In some implementations, the server 106 may determine, based on the image classifier, a not relevant probability that the frame contains no traffic light or that the frame contains one or more traffic lights that are not relevant to the vehicle 104, and/or a green light probability that the frame contains at least one relevant green traffic light for the vehicle 104.

The server 106 may determine whether the vehicle is associated with a traffic light violation based on the violation score in relation to a threshold. The server may compare the violation score to the threshold, and depending on whether the violation score satisfies the threshold, the server 106 may predict that the traffic light violation has occurred. The traffic light violation may involve the vehicle driving past the intersection when the traffic light is red, and no exception exists that lawfully permits the vehicle to cross the intersection when the traffic light is red. A detection of the traffic light violation may be based on video information, speed information, and heuristics, and the detection of the traffic light violation may be without a use of satellite map information. In other words, the detection of the traffic light violation may not be based on satellite map information.

In some implementations, as part of a traffic light violation detector, multiple time series may be combined together in a single violation score. A time series may be given by: R(t)=OD(t)*RT(t)*P_{red}(t), where t denotes a given frame, OD is associated with object detection, RT is associated with right turn detection, and P_{red} is associated with a probability of a relevant red traffic light. When a value of R(t) is close to one, the vehicle 104 may be in the presence of a relevant red traffic light since the object detection mask is not zero, P_{red} is close to one, and the vehicle 104 is not turning right since RT(t) is not zero.

In some implementations, an aggregation of the time series P_{not_relevant} over a rolling window of length T may be represented by:

$$N R ( t ) = \frac{1}{T} {\sum }_{x = t}^{t + T} {P}_{{not}_{relevant}} ( x ) ,$$

where P_{not_relevant} is associated with a probability of no relevant traffic light. Ideally, right after the vehicle 104 passes through the intersection, a value may change from zero to close to one (e.g., a probability of any traffic light state dropped to zero), meaning that no traffic light is detected in an upcoming time window of length T. Before passing the intersection, one of the probabilities for other colors (e.g., green, yellow, or red) may be close to one. When R(t)*NR(t) is close to one for some value t′, then at time t′ the vehicle 104 may have run a red light (which may not necessarily mean a traffic light violation). The vehicle 104 may have stopped late at the intersection and the traffic light may no longer be visible, or a camera installation may cause a camera to be pointed downward, and in proximity of the intersection, so that the traffic light may quickly disappear from the camera field of view. In these cases, no traffic light violation may actually occur, but a false positive may be triggered. To account for such cases, the speed of the vehicle may be considered. When the speed is below a given threshold, the traffic light violation may not be considered to be possible, so an actual score may be given by: violation_score_{R}=R(t)*NR(t)*S(t), where S is associated with the speed detection.

In some implementations, to make the violation score more robust, filtering may be applied to a speed mask. The filtering may involve calculating a mean speed over a rolling window. If the traffic light violation happens at a very low speed, a detection of the traffic light violation may not be possible. A GPS speed may already have some uncertainty and considering zero as a limit value without any tolerance may not be feasible.

In some implementations, a time series P_{green} may be considered for a highway ramp scenario (e.g., a traffic light flashes between green and red), where P_{green} is associated with a probability of a relevant green traffic light. When a relevant traffic light state transitions from red to green (or green to red), a grace period may be used for the next few seconds. The grace period may serve to artificially set a score to zero. For detecting a transition from red to green (or green to red), the time series P_{green} may be aggregated and a value of its product may be monitored with R(t), such that:

$$G R ( t ) = \frac{1}{T} {\sum }_{x = t}^{t + T} {P}_{green} ( x ) ,$$

where for a red-green transition to occur, R(t)*GR(t)˜1 should be satisfied.

In some implementations, one scenario that may be accounted for is flashing traffic lights. In this scenario, a state transition from red to not relevant may be periodic. In NR(t), an average of a not relevant probability may be taken over a next T seconds. When a flashing period is less than T (e.g., 0.5*T), NR will be equal to 0.5, and hence this particular event may be ranked in a lower position then an actual red light violation. The traffic light violation may be predicated when a score is above a threshold/confidence score, where the threshold/confidence score may be determined by monitoring a performance of an algorithm in a dataset. An additional minimum filter may be applied to the score, which may avoid a bad prediction of a relevant state, even when just happening for one frame, leading to a false positive. Further, an anti-causal window may be used, such that the score cannot be computed in real time, but rather with a delay that is at least equal to a length of a time window.

In some implementations, the server 106 may determine, based on the image classifier, a yellow light probability that the frame contains at least one relevant yellow traffic light for the vehicle 104. The server 106 may determine, based on the image classifier, the not relevant probability that the frame contains no traffic light or that the frame contains one or more traffic lights that are not relevant to the vehicle 104. The server 106 may perform, based on the sensor information, the speed detection that indicates the speed associated with the vehicle 104 during the frame. The server 106 may determine a yellow stop score that indicates a severity of a yellow light violation. The yellow stop score may be based on the speed and a duration of a detected yellow relevant traffic light. The server 106 may calculate the violation score based on the object detection, the turn detection, the yellow light probability, the not relevant probability, the speed detection, and the yellow stop score.

In some implementations, the vehicle 104 may run a yellow light. Passing through a traffic light regulated stop with a yellow light turned on may not necessarily be a traffic light violation. The vehicle 104 should stop at the traffic light when possible, and the vehicle 104 is permitted to not stop at the traffic light when not possible. Given that Y(t)=OD(t)*RT(t)*P_{yellow}(t), when Y(t)*NR(t) is close to one for some value t′, a yellow light violation may have happened at t′. In this example, P_{yellow} is associated with a probability of a relevant yellow traffic light. A violation score may be represented by: violation_scorey=Y(t)*NR(t)*S(t)*YellowStopScore, where YellowStopScore may capture a severity of a yellow light violation. The severity of the yellow light violation may leverage a speed of the vehicle 104 and a duration of a detected yellow relevant traffic light. In a specific example, YellowStopScore=Duration_{Y}(t)*60/min(S(t), 60). A higher duration of the yellow traffic light may result in a higher YellowStopScore (e.g., a yellow light that is seen for a longer period of time gives a driver of the vehicle 104 more opportunity to stop the vehicle 104 in time). On the other hand, a duration may be divided by a term that considers a minimum of the speed and a threshold that is set to 60 km/h. In this way, when the vehicle 104 is traveling 60 km/h or more, this term may be set to one. When the vehicle 104 is traveling at a slower speed (e.g., a speed less than 60 km/h), this term may increase and raise an overall YellowStopScore. For a vehicle 104 that is traveling relatively fast, stopping at a yellow light may be less feasible, but for a vehicle 104 that is traveling relatively slow, stopping at the yellow light may be more feasible.

In some implementations, the server 106 may transmit, to the computing device 108, a notification that indicates whether the vehicle 104 is associated with the traffic light violation. The computing device 108 may be associated with the driver of the vehicle 104. In this example, the notification may indicate a recommendation for the driver of the vehicle 104 to improve a driving behavior and increase safety in response to the traffic light violation. The computing device 108 may be associated with a supervisor of the driver. In this example, the notification may indicate that the driver was involved in the traffic light violation.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example 200 associated with object detection.

In some implementations, object detection may be used for road scene analysis. Object detection may be used to determine, at each frame of a video, a location, a size, and/or a shape of each traffic light. Object detection may not provide information regarding traffic light relevance and state, but may be used to check the presence of traffic lights in a given video. An absence of a traffic light in the video, as determined using object detection, may result in no detection of a traffic light violation because a presence of a traffic light is critical for detecting the traffic light violation.

In some implementations, results of object detection may be used to create a mask to select time windows that may be of interest for traffic light violation detection in the given video. A time series given by a maximum area of the traffic lights detected in all frames of the video may be analyzed. When no traffic light is present, a value of the time series may be set to zero. Intervals of interest may be an interval in which a value of the time series is above a certain threshold. A resulting mask may be a time series that is set to zero when the value is below the threshold and set to one elsewhere. The resulting mask may be known as a square wave.

As shown in FIG. 2, for object detection, when a vehicle approaches an intersection, a maximum traffic light area in an image of a scene may increase from zero to a certain value, which may be due to the movement of the vehicle toward a traffic light. When the vehicle is stopped at the intersection, the maximum traffic light area may be constant for a period of time. When the vehicle passes the intersection, the traffic light may no longer be detected, so the maximum traffic light area may drop to zero. An interval of interest may start as the vehicle approaches the intersection (e.g., once a certain threshold is satisfied) and the area of interest may end when the vehicle passes the intersection. A mask (OD) may be created that corresponds to the interval of interest. The resulting mask may be set to one during the interval of interest, and the resulting mask may be set to zero at other times.

As indicated above, FIG. 2 is provided as an example. Other examples may differ from what is described with regard to FIG. 2.

FIG. 3 is a diagram of an example 300 associated with turn detection.

In some implementations, turn detection may be used for detecting a right turn of a vehicle. When the vehicle is permitted to turn right at an intersection at a red light, a traffic light violation should not be predicted. The vehicle may initially stop at the red light, and then after a period of time (e.g., two seconds), the vehicle may be lawfully permitted to make the right turn while the traffic light is still red. The vehicle may have to initially stop at the red light based on a traffic sign that instructs a driver of the vehicle to stop. For the turn detection, a z-axis component of an angular velocity measured by a gyroscope sensor in the camera may be used. When a value of the z-axis component is a negative value, the vehicle may be turning right. A mask may be created, where the mask may start from an angular velocity checking whenever the value is below a given negative threshold. The mask may be made narrower by adding a fixed buffer of X seconds before and after the zero seconds, where X is a positive integer. An estimate may become more robust when, instead of an instantaneous value, a mean filter is applied on the angular velocity.

As shown in FIG. 3, for turn detection, the z-axis component of the angular velocity may be tracked over a period of time. A value of the z-axis component being below a given negative threshold may indicate that the vehicle is making the right turn. A mask (RT) may be created, starting from a positive value of the z-axis component, to check whenever the value falls below the given negative threshold, which may indicate that the vehicle is making the right turn. The mask may be set to one when the value of the z-axis component is above the given negative threshold. The mask may be set to zero when the value of the value of the z-axis component reaches the given negative threshold and a right turn is detected.

As indicated above, FIG. 3 is provided as an example. Other examples may differ from what is described with regard to FIG. 3.

FIG. 4 is a diagram of an example 400 associated with speed detection.

As shown in FIG. 4, for speed detection, a detection of a traffic light violation may depend on a speed of a vehicle. The vehicle may have to move at a given speed in order to run a red light. When the vehicle is stopped, a traffic light violation may not be possible. The speed of the vehicle may be measured using a GPS associated with the vehicle. A mask (S) may be created to track the speed of the vehicle over a period of time. When the speed is below a certain threshold, the mask may be set to zero. When the speed is above the certain threshold, the mask may be set to one.

As indicated above, FIG. 4 is provided as an example. Other examples may differ from what is described with regard to FIG. 4.

FIG. 5 is a diagram of an example 500 associated with traffic light state classification.

In some implementations, for traffic light state classification, an image classifier may be used to categorize road images into different classes. An image in which no traffic light is present, or an image that has at least one traffic light but none of the traffic lights are relevant for a vehicle that is capturing the image, may be associated with a not relevant class. An image in which at least one relevant green traffic light is present for the vehicle may be associated with a relevant green class. An image in which at least one relevant yellow traffic light is present for the vehicle may be associated with a relevant yellow class. An image in which at least one relevant red traffic light is present for the vehicle may be associated with a relevant red class. The image classifier may be run for each frame in a video, which may produce a time series containing probabilities for each state (e.g., not relevant, relevant green, relevant yellow, or relevant red). A complementary value to a sum of the probabilities of each of the colors (e.g., green, yellow, and red) may represent a probably that no relevant traffic light is present for the vehicle. Each one of the time series may be represented by P_{not_relevant}, P_{green}, P_{yellow}, and P_{red}, where P_{not_relevant} is associated with a probability of no relevant traffic light, P_{green} is associated with a probability of a relevant green traffic light, P_{yellow} is associated with a probability of a relevant yellow traffic light, and P_{red} is associated with a probability of a relevant red traffic light. In some cases, the image classifier may not be used, but rather an object detector with multiple attributes (e.g., one attribute for traffic light relevance and one attribute for state) may be used instead. When a probability of a given state drops to zero and a dominant probability becomes not relevant, the vehicle may have just passed an intersection.

As shown in FIG. 5, a time series of images may be captured by a camera onboard a vehicle. Initially, the image classifier may determine that one or more frames indicate that no relevant traffic light is likely, which may be based on a state probability. After a certain point of time, the image classifier may determine that one or more frames indicate that a green traffic light is likely, which may be based on the state probability. The image classifier may then determine that one or more frames indicate that a yellow light is likely, which may be based on the state probability. The image classifier may then determine that one or more frames indicate that a red light is likely, which may be based on the state probability. A traffic light may change from green, to yellow, and to red as the vehicle approaches an intersection. After a certain point of time at which the red light is likely, the state probability may switch to zero, at which point no relevant traffic light is likely. The state probability may switch to zero as a result of the vehicle passing the intersection (e.g., the red light is no longer present in the frame). When the vehicle passes the red light, a potential traffic light violation may occur. For example, a traffic light violation may occur when the vehicle passes the intersection and the traffic light is still red. Further, as shown in FIG. 5, a time series of P_{red} may indicate a value close to zero when no relevant traffic light is likely, when the green light is likely, and when the yellow light is likely. When the red light becomes likely, P_{red} may increase to one (indicating that a presence of at least one relevant red traffic light is very likely).

As indicated above, FIG. 5 is provided as an example. Other examples may differ from what is described with regard to FIG. 5.

### Identifying Relevant Traffic Lights in Driving Scenes

Safely navigating road intersections may pose a significant challenge for intelligent vehicles, demanding a deep semantic understanding of a surrounding environment. Tasks such as locating pedestrians, identifying other vehicles, and/or predicting their trajectories and orientations may be inherently complex. One crucial task may involve a recognition of traffic lights from images captured by dashboard cameras, comprising both a localization of all traffic lights in a scene and a determination of their current state, among red, yellow, or green. However, recognition alone may not determine a complete course of action for a vehicle. In situations where multiple traffic lights are present, potentially with different states, an identification of a relevant traffic light for an ego-vehicle may be needed. An ability to detect a relevant traffic light in a red state (“relevant red” for short) may be useful in both real-time, to notify a driver if they are approaching an intersection too fast, and after the fact, to identify dangerous driving behaviors and coach drivers on their violations.

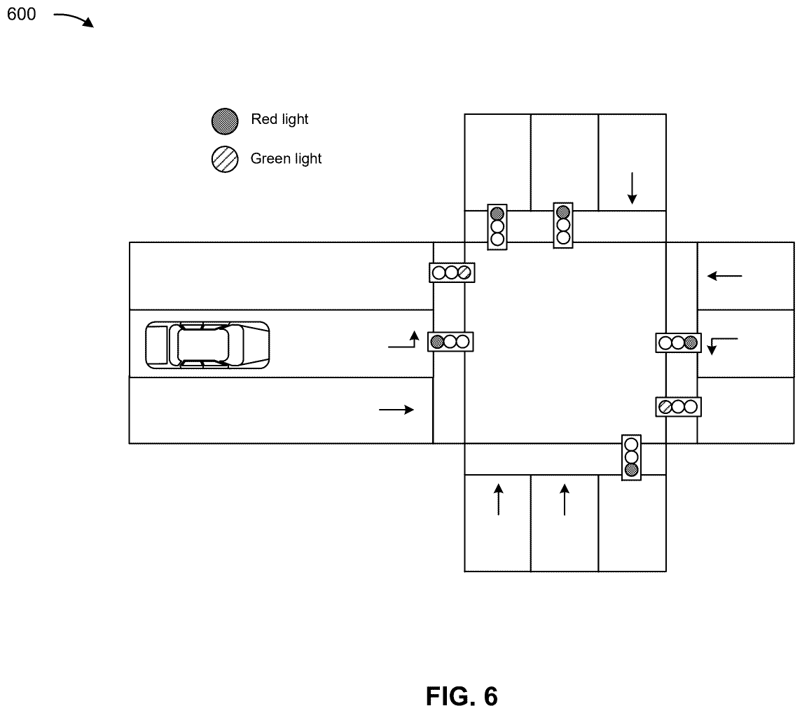

FIG. 6 is a diagram of an example 600 associated with an intersection.

As shown in FIG. 6, in an intersection, a detection task may localize seven traffic lights in different states. A current lane for an ego-vehicle may be regulated by a red traffic light associated with a left turn, while a green traffic light for continuing straight may not be relevant for the vehicle. Determining which traffic light is relevant may be needed to understand a correct action to take by the vehicle.

As indicated above, FIG. 6 is provided as an example. Other examples may differ from what is described with regard to FIG. 6.

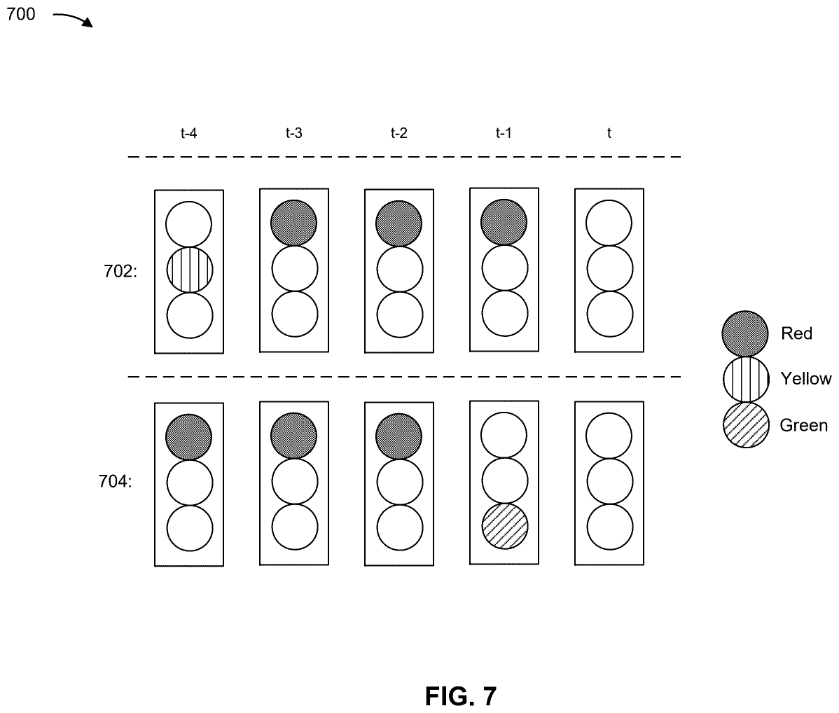

FIG. 7 is a diagram of an example 700 associated with relevant traffic light sequences in a video.

As shown by reference number 702, assuming that an ego-vehicle is moving at time t, in a first row, a sequence of red states followed by a lack of relevant traffic lights may indicate that a red light violation has likely occurred. As shown by reference number 704, in a second row, a sequence of red lights followed by a green light (e.g., a last detection being a green relevant traffic light) may indicate that no violations have occurred.

As indicated above, FIG. 7 is provided as an example. Other examples may differ from what is described with regard to FIG. 7.

Detecting and recognizing states of traffic lights may be critical tasks for both advanced driver assistance systems (ADAS) and autonomous driving. To develop applications focused on these objectives, a diverse range of image datasets may be gathered. Typically, these datasets may be collected from recordings of dashboard cameras in order to simulate a visual experience of a driver.

One traffic light dataset is the LISA Traffic Light Dataset, which currently includes approximately 40,000 images collected in the United States. This dataset offers bounding box and state annotations for each traffic light in every image. Another traffic light dataset is the Bosch Small Traffic Lights Dataset (BSTLD), which currently includes around 25,000 traffic light annotations. Deep learning models trained on these datasets may aim at detecting each traffic light in a scene and assessing its state. However, both datasets do indicate which traffic lights are relevant for a driver.

To cover this gap, some traffic light datasets may include annotations on a relevance of each traffic light with respect to ego-vehicles, in addition to traditional annotations. A DriveU Traffic Light Dataset (DTLD) considers traffic light relevance and currently includes more than 230,000 annotations on about 24,000 distinct traffic lights across approximately 50,000 images. The annotations may encompass a comprehensive set of labels, including orientation, relevance, state, and pictogram. The DTLD contains data collected in various cities and is a large-scale, publicly available dataset that includes attributes of relevance for each traffic light. Two other traffic light datasets, Cityscape TL++ and LAVA, may incorporate an attribute resembling the concept of relevance. Cityscape TL++ may enhance an original Cityscape dataset with additional labels specifically related to traffic lights. This augmentation may apply to a subset of images in an original dataset captured in an urban scenario. LAVA may contain images captured in the United States and, for each traffic light, may define a saliency attribute aligning with a concept of relevance.

As part of a traffic light recognition, visually recognizing traffic lights may involve identifying all traffic lights within an image and determining their current states. Various techniques may be used for this task, and may be broadly categorized into modifications of generic object detectors, multi-stage methodologies, and task-specific single-stage approaches. For example, a region-based convolutional neural network (R-CNN) architecture may be adapted specifically for traffic light detection and recognition, which may involve adjusting an anchor box generator and a classification stage to compute both states and pictograms of detected traffic lights. In another example, a standard YOLO may be employed for traffic light localization and a custom convolutional network may be leveraged, which may be fed with cropped bounding boxes to infer current states of detected traffic lights.

However, such techniques may not explicitly associate the detected traffic lights with an ego-vehicle, which may be a crucial task in many driving applications. Assessing a relevance of a traffic light with respect to the ego-vehicle may typically involve relying on additional information, such as high definition (HD) maps, which include precise positions of the vehicle together with road components, such as lane boundaries, traffic signs, and traffic lights.

Some techniques may be used to identify the relevant traffic lights from visual input. In one example, an image regression model may be used to localize an area of an image where a relevant traffic light should appear. In another example, an inverse perspective mapping (IPM) may be used to obtain a bird's eye view of the road, and a convolutional neural network (CNN) may be used to predict an assignment of relevant traffic lights to the ego-vehicle. In another example, a loss function may be modified to penalize errors committed on relevant traffic lights, which may indirectly improve performance on those samples, though not explicitly detecting their relevance. In another example, a global task of determining whether an image contains at least one relevant red light may be solved, but without focusing on a localization of each traffic light in the scene.

An accurate location and classification of traffic lights in driving scenes may be crucial for enhancing road scene understanding in various intelligent vehicle applications. However, an ability to accurately determine which traffic lights are relevant for the ego-vehicle may be challenging. A high accuracy may be needed to ensure that a certain traffic light is not mistakenly identified as being relevant when in fact another traffic light is actually relevant, thereby potentially causing a high risk of harm. Further, when identifying the relevant traffic lights, color alone of a traffic light may be insufficient for detecting whether a given traffic light is relevant or not relevant.

In some implementations, when identifying relevant traffic lights in driving scenes, a local task of identifying the state and relevance of each traffic light in an image may be employed, as well as a related global task of recommending a correct course of action for the ego-vehicle (e.g., whether the ego-vehicle should stop or continue moving). Each traffic light may be localized and a relevance of each traffic light may be identified with respect to the ego-vehicle, and a global recommendation may be generated. In some implementations, since commonly used traffic light datasets lack data regarding relevance, a Traffic Light Dataset (TLD) may be introduced. The TLD may feature, for example, approximately 3000 labeled images depicting various road intersections with bounding box, state, and relevance annotations for each traffic light. A unified approach to addressing both the local task and the global task may lead to significant improvements over approaches that do not exploit synergies between the local and global tasks.

In some implementations, a computing device may detect traffic lights in images captured by dashboard cameras, determine their states, and assess their relevance to the ego-vehicle. The computing device may detect the traffic lights, determine the states, and assess relevance in accordance with the local task. By localizing traffic lights in a scene and predicting their attributes, interpretable deep scene understanding may be enabled, which may be essential for various safety-critical applications. In some implementations, the computing device may generate a global, image-level recommendation for the ego-vehicle to either stop or proceed based on the states of the relevant traffic lights. This global prediction may enable high-level reasoning, such as detecting possible traffic light violations.

In some implementations, the computing device may perform such local and global tasks using images alone. The computing device may not rely on positioning systems and HD maps for traffic light identification. The computing device may provide a more widely applicable solution, as creating HD map annotations can be costly. Given the lack of public datasets with annotations of the relevance of traffic lights, the TLD may be generated for such a purpose. The TLD may be a thoroughly curated dataset collected in the United States and designed to address shortcomings of existing datasets. The TLD may provide information about the relevance of each traffic light in the scene, together with its bounding box and current state. In some implementations, in order to perform the local and global tasks, the computing device may employ a deep convolutional neural network that is designed to localize all traffic lights in the scene, identify their relevance and state, and also generate a global image-level prediction in a combined fashion. Solving the local and global tasks simultaneously may improve performance on both tasks.

In some implementations, the computing device may be responsible for recognizing and prioritizing relevant traffic lights for intelligent vehicles at road intersections, which may lead to improved road safety for all users by providing critical information for timely decision-making at intersections. Additionally, the computing device may aid in post-analysis for fleet management software, by helping to identify risky driving behaviors and enabling effective coaching for improved driving practices. In some implementations, the TLD may address limitations in existing datasets. The TLD may provide a relevance attribute and state information for each traffic light in approximately 3000 images (for example) collected by dashboard cameras in the United States, thereby offering valuable diversity in terms of intersections. The computing device may combine an adapted Faster R-CNN object detector for localizing and predicting traffic light attributes with an image classifier for making global predictions, which may provide superiority over heuristic-based and deep-learning approaches. Such a model may achieve high performance in both traffic light detection and image-level predictions on the TLD, emphasizing its robustness in real-world scenarios. In some implementations, the model may be adapted to a wider range of geographical contexts and diverse driving environments. The TLD may be enhanced with additional fine-grained state attributes, such as pictograms, which may improve the model's effectiveness in real-world applications. Additionally, relevance estimation may be refined by incorporating temporal information, and extending the TLD to include video sequences may enhance the model's performance in predicting traffic light relevance over time. Further, labeled video sequences may help to address the challenging task of establishing a legality of maneuvers.

In some implementations, by performing the local and global tasks using the TLD, an accurate location and classification of traffic lights in driving scenes may be achieved. Such an approach may provide an ability to accurately determine which traffic lights are relevant for the ego-vehicle. As a result, traffic lights may be ensured to not be mistakenly identified as being relevant when in fact another traffic light is actually relevant, thereby avoiding a risk of harm.

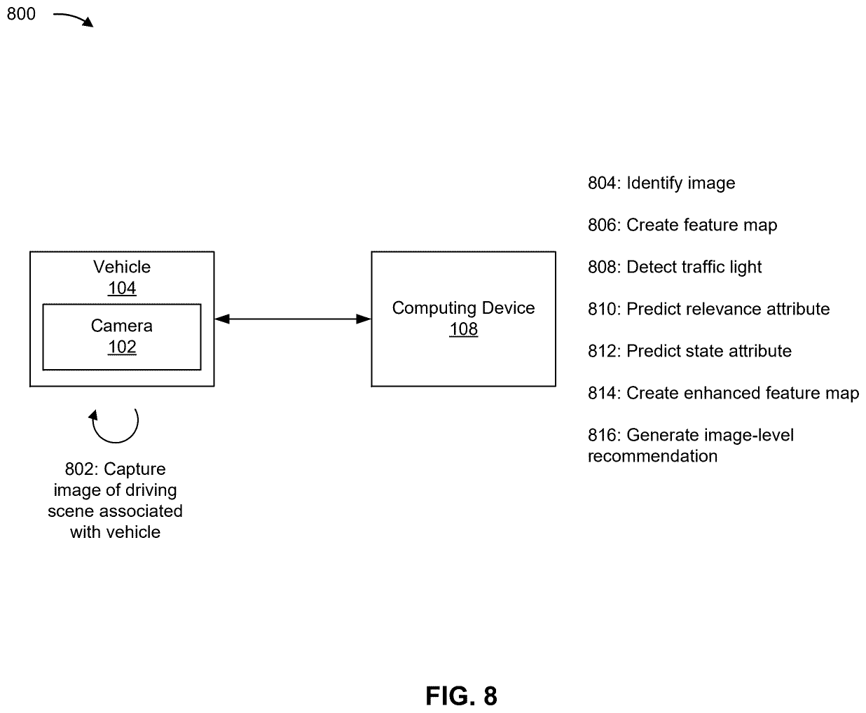

FIG. 8 is a diagram of an example 800 associated with identifying relevant traffic lights in driving scenes. As shown in FIG. 8, example 800 includes a camera 102, a vehicle 104, and a computing device 108.

As shown by reference number 802, the camera 102 may capture an image of a driving scene associated with the vehicle 104. The driving scene may be a scene toward a front of the vehicle 104, a scene toward a back of the vehicle 104, and/or a scene toward a side of the vehicle 104. The camera 102 may capture the image when the vehicle 104 is moving. The camera 102 may be onboard the vehicle 104. For example, the camera 102 may be installed on a dashboard of the vehicle 104.

As shown by reference number 804, the camera 102 may send the image to the computing device 108 for processing. The computing device 108 may be associated with the vehicle 104, or alternatively, the computing device 108 may be associated with a cloud computing environment.

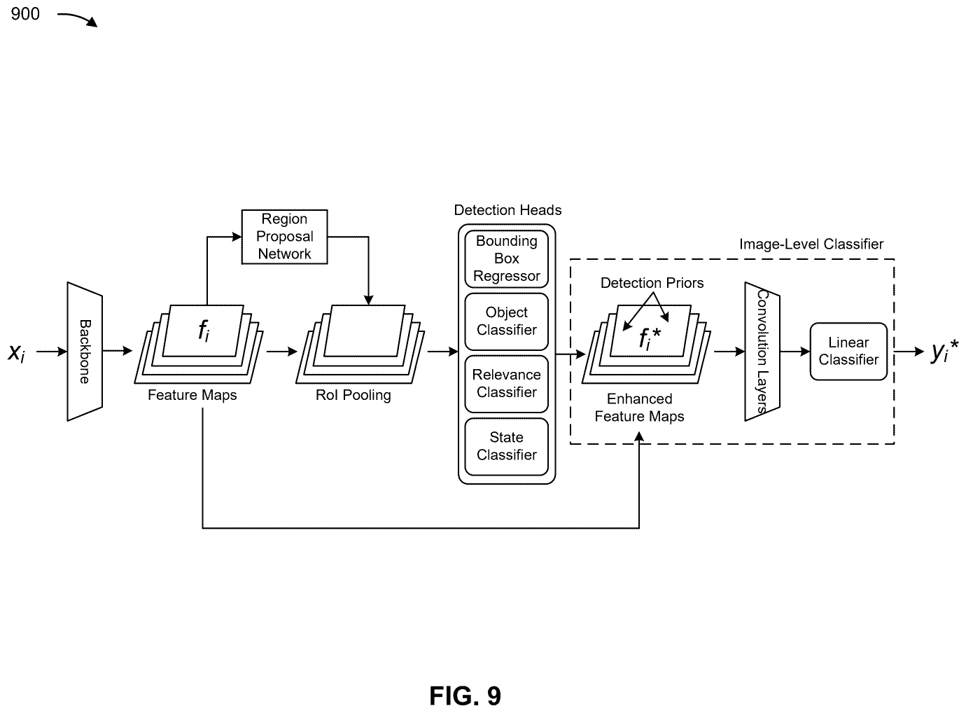

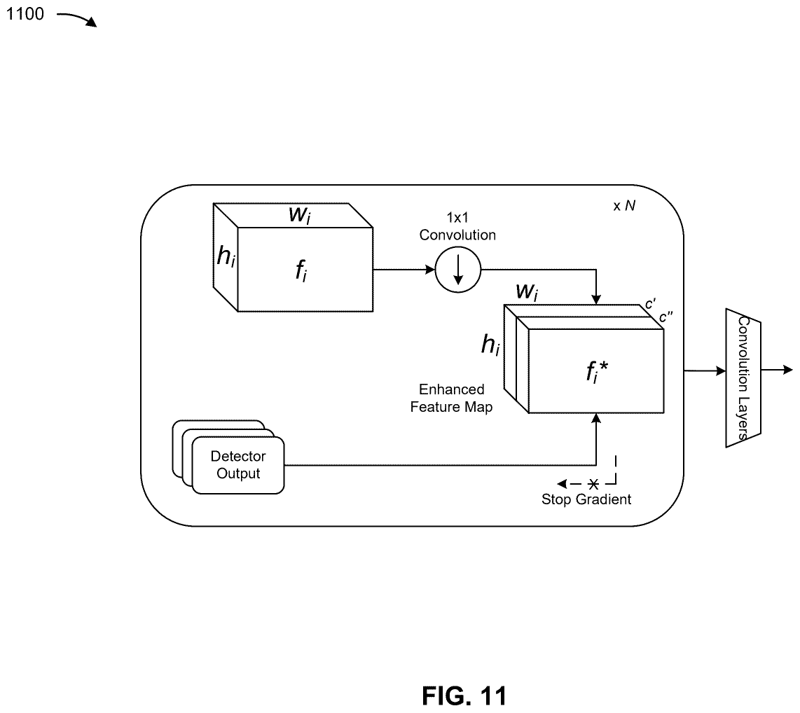

As shown by reference number 806, the computing device 108 may create a feature map based on the image. The feature map may represent specific features of the image, where the image may be inputted to a convolutional layer. An output of the convolutional layer may be the feature map. The feature map may indicate low-level features associated with the image, such as edges, corners, and/or basic shapes. The feature map may represent a response of a particular filter applied to the image. Additional feature maps may be created, which may represent higher-level features, such as shapes, textures, and/or object parts. An example of the feature map is shown in FIGS. 9 and 11.

As shown by reference number 808, the computing device 108 may detect a traffic light associated with the image using an object classifier. The computing device 108 may detect, using the object classifier, the traffic light based on the feature map. The object classifier may be capable of object detection, where the object detection may be based on the feature map. In some cases, the traffic light may be one of a plurality of traffic lights associated with the image, but not all traffic lights may be relevant to the vehicle 104. An example of the object classifier is shown in FIG. 9.

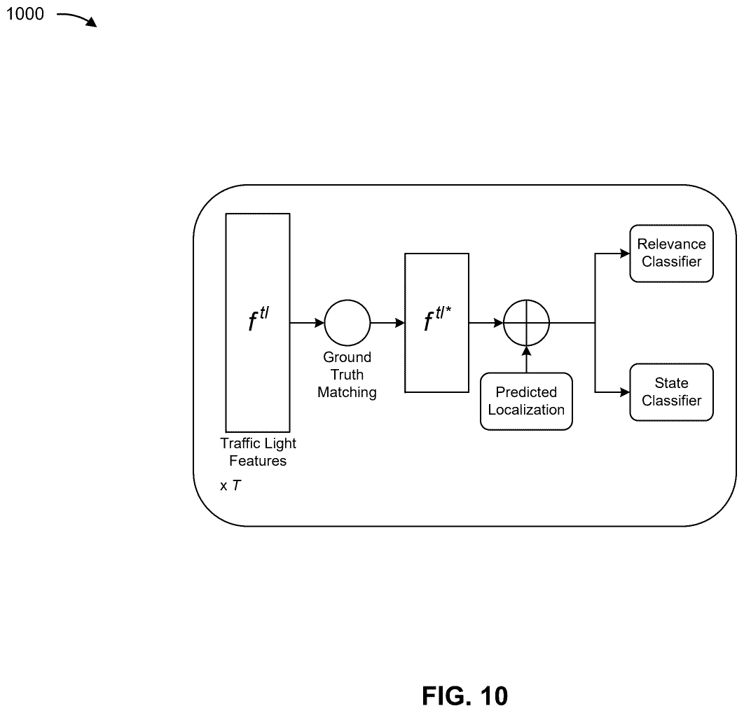

As shown by reference number 810, the computing device 108 may predict a relevance attribute of the traffic light using a relevance classifier. The computing device 108 may determine the relevance attribute in accordance with a local task. A predicted relevance of the traffic light may indicate whether the traffic light is relevant to the vehicle 104. For example, the predicted relevance may be a score that indicates whether or not the traffic light is relevant to the vehicle 104. The computing device 108 may use the relevance classifier, which uses the feature map as an input, to predict the relevance attribute. In some implementations, the computing device 108 may identify a feature representation of the traffic light. The computing device 108 may modify the feature representation based on a concatenation of normalized coordinates of a predicted bounding box for the traffic light, to obtain a resulting output. The computing device 108 may provide the resulting output as an input to the relevance classifier. An example of the relevance classifier is shown in FIGS. 9-10.

As shown by reference number 812, the computing device 108 may predict a state attribute of the traffic light using a state classifier. The computing device 108 may determine the state attribute in accordance with the local task. A predicted state of the traffic light may indicate a color associated with the traffic light. For example, the predicted state may be a green traffic light, a yellow traffic light, or a red traffic light. The computing device 108 may use the state classifier, which uses the feature map as the input, to predict the state attribute. In some implementations, the computing device 108 may identify the feature representation of the traffic light. The computing device 108 may modify the feature representation based on the concatenation of normalized coordinates of the predicted bounding box for the traffic light, to obtain the resulting output. The computing device 108 may provide the resulting output as an input to the state classifier. An example of the state classifier is shown in FIGS. 9-10.

As shown by reference number 814, the computing device 108 may create an enhanced feature map based on the feature map and an output of the object detector. The enhanced feature map may be based on the feature map, the predicted relevance attribute of the traffic light, the predicted state attribute of the traffic light, and a predicted bounding box for the traffic light. The output of the object detector may include the predicted relevance attribute, the predicted state attribute, and the predicted bounding box. An example of the enhanced feature map is shown in FIGS. 9 and 11.

As shown by reference number 816, the computing device 108 may generate an image-level recommendation using an image-level classifier. The image-level recommendation may be based on the enhanced feature map being provided as an input to the image-level classifier. The computing device 108 may determine the image-level recommendation, in conjunction with the relevance attribute and the state attribute, in accordance with a global task. The image-level recommendation may indicate that the vehicle 104 is to stop when a relevant traffic light is red or yellow. Alternatively, the image-level recommendation may indicate that the vehicle 104 is not required to stop when the relevant traffic light is green. In some implementations, the computing device 108 may generate the image-level recommendation based on a convolutional encoder. The convolutional encoder may receive, as an input, the enhanced feature map, and the convolutional encoder may determine the image-level recommendation based on the enhanced feature map. An example of the image-level classifier is shown in FIG. 9.

In some implementations, the computing device 108 may use an R-CNN based architecture, such as a F aster R-CNN detector, to identify a relevant traffic light in the image. The detector may be a component of an end-to-end architecture that employs the relevance classifier and the state classifier, used downstream by an image-level classifier, which may provide, as an output, the image-level recommendation (or image-level prediction).

The computing device 108 may identify the relevant traffic light in the image without using a positioning system or an HD map. In some implementations, the computing device 108 may identify a risky driving behavior based on the image-level recommendation. The computing device 108 may provide a notification based on the risky driving behavior. The notification may indicate a recommended driving practice in view of the risky driving behavior.

As indicated above, FIG. 8 is provided as an example. Other examples may differ from what is described with regard to FIG. 8.

In some implementations, a common drawback of public datasets may be the lack of specific information regarding the relevance of each traffic light with respect to the ego-vehicle, especially in US-based datasets. The DTLD and Cityscape TL++ may provide annotations on relevance, both sourced from images captured on roads in Germany. A lack of annotations in a United States context, very different from the European one, may lead to a significant performance drop when models trained on those datasets are tested in a North American domain. To address these limitations, the TLD may be a new traffic dataset that is used for identifying relevant traffic lights in driving scenes. The TLD may be curated to encompass necessary information for solving this task in a United States scenario.

In some implementations, in the TLD, for data collections, images may be collected from cameras continuously recording road-facing video footage. Cameras may be installed on the windshields of hundreds of vehicles of different sizes and in different positions, guaranteeing diversity in terms of height and orientation. A resolution of the frames may be approximately 1280×720 pixels. A diagonal field of view of the cameras may be approximately 150 degrees. Images may be anonymized to obfuscate license plates, reflections on windshields, logos on hoods of ego-vehicles, and pedestrians.

In some implementations, in the TLD, for data annotation, in an image featuring traffic lights captured from a road-facing camera, a specific traffic light may be deemed relevant when that traffic light is the one that the driver should focus on when deciding whether to stop or proceed. A binary attribute may be assigned to each traffic light in the image. A traffic light may be labeled as relevant when that traffic light is in the lane occupied by the ego-vehicle. All other traffic lights may be categorized as not relevant. In cases of ambiguity, such as a vehicle crossing lanes, or no clear lane markings, the uncertainty may be resolved by examining an orientation of the ego-vehicle. Based on this assessment, an informed guess may be made about the intentions of the driver of the vehicle, and the traffic light may be labeled accordingly. This definition may align with the concept of relevance, as well as the notion of saliency. A state of a traffic light may be defined as the color that is displayed, which may be one of four values: red (stop), yellow (slow down), green (go), or unknown. The unknown class may be used in case of occlusions, when no lights are on, or when traffic lights are too distant from the ego-vehicle to discern their state. A logical constraint that directly stems from these labeling rules is that within the same image, when multiple relevant traffic lights exist, they cannot have different states.

In some implementations, the TLD may include a plurality of images, each with annotations. In an image, red or green boxes may indicate a presence of a red or a green traffic light, respectively, and blue boxes may indicate a traffic light with an unknown state. Boxes with double edges may indicate that the traffic light is considered relevant for the ego-vehicle.

As an example, a first image after an annotation pipeline may be associated with a night scenario. In the first image, an association of a traffic light to the ego-lane may be clear. In this scenario, a vehicle may be going to turn right with a clear association between the ego-lane and the traffic light. As another example, a second image after the annotation pipeline may be associated with a changing lane scenario. In the second image, a situation may be depicted in which the relevant traffic light may be labeled, assuming that a driver's intention is to move into a left-most lane. In this scenario, the relevant traffic light may be labeled under an assumption that the driver's intention is to move into the left lane.

In some implementations, an attribute distribution may be analyzed in the TLD, for example, using a histogram. The histogram may illustrate a distribution of labeled attributes. The histogram may indicate a high imbalance toward a “not relevant” class in attribute relevance, since on average, only one traffic light may be identified as relevant per intersection. Similarly, a state attribute may exhibit a high degree of imbalance because, for most of the not relevant traffic lights, knowing their state may be difficult or even impossible.

In some implementations, the TLD may be compared with the DTLD, where the DTLD may typically be recognized as the most comprehensive large-scale, publicly available dataset on traffic lights that includes a relevance attribute for each traffic light. The DTLD may include approximately 40,000 images sampled at 1 Hertz (Hz) from 2,110 videos recorded in eleven different German cities. Each video may be centered around a single intersection. The recordings may be made using the same vehicle, during daylight and mostly under favorable weather conditions. Since multiple frames may be sampled from the same video, the DTLD may contain highly correlated images, featuring the same relevant traffic lights under very similar conditions. In comparison, the TLD may be a smaller dataset of approximately 3000 labeled images, but with increased diversity. In the TLD, each image may be extracted from a different video (e.g., a different intersection), recorded in various areas of the United States. The TLD may also contain a wider range of environmental conditions, including weather (e.g., favorable and adverse weather conditions) and different times of the day (e.g., day and night), ensuring a more comprehensive representation of real-world driving scenes and visibility conditions.

In some implementations, regarding a geographical context, road intersections across the world may vary in several aspects, including the types and the positions of traffic lights. For example, European traffic lights, characterized by their vertical orientation and placement before an intersection, may differ from United States counterparts, which are often positioned after the crossroads and span a broader range of shapes. As a result, a distribution of an area and aspect ratio of traffic lights may vary significantly, and a model trained on data from a specific geographical region may encounter difficulties in effectively generalizing to a different domain.

In some implementations, a difference in the aspect ratio of a bounding box for traffic lights between a Germany scenario (DTLD) and a United States scenario (TLD) may be analyzed. An aspect-ratio distribution (width over height) for the DTLD may be centered at approximately 0.3, which may be consistent with the observation that European traffic lights typically have a vertical orientation with three circular lights. In contrast, the TLD may exhibit a different distribution, which may be due to the larger diversity in the shape of traffic lights in the United States (sometimes even horizontal). In the TLD, traffic lights may exhibit a higher variance, as compared to those in the DTLD, with a distribution showing a noticeable right tail toward ratio values exceeding 1.

In some implementations, a distribution of the size of traffic lights, stratified by their relevance, may reveal a difference due to a distinct spatial positioning of the signals in two geographical domains. In the United States, when approaching an intersection, a largest (in terms of its bounding box area) visible traffic light may be irrelevant for the ego-vehicle, as the largest visible traffic light may correspond to the back of a traffic light facing an opposite direction. In contrast, in Germany, a largest area may often correspond to a frontal traffic light, serving as a more reliable heuristic for determining relevance. Such a difference may be analyzed by presenting a distribution of a normalized area of traffic lights, categorized by their relevance across the two datasets individually. A normalization process may set a largest area to one and may rescale other areas accordingly. In the DTLD, a distribution of the area for not relevant traffic lights may differ from that of the relevant ones. Conversely, in the TLD, distributions may be similar, indicating that the area of a box may not provide useful information about the relevance of the box itself. In other words, the DTLD may provide a significant difference between the distributions of relevant and non-relevant traffic lights, whereas the TLD may provide distributions of relevant and non-relevant traffic lights that are considerably more similar to each other.

In some implementations, several datasets on traffic lights, including BSTLD and DTLD, may be acquired using a single vehicle, maintaining a fixed relative position of the camera in all images. However, this fixed camera setup may hide the complexity found in real-world scenarios, where models may need to handle images captured from different vehicles with varying camera positions and orientations. To emphasize the diversity in data distributions, density maps of traffic light locations may be formed for the DTLD and the TLD datasets, which may indicate that a spatial distribution within the images may vary. In the DTLD, a clear demarcation may exist between areas where traffic lights can appear and those where they cannot, due to the same camera pose. In the DTLD, a horizon and vanishing point of an image plane may be identified from the distribution of traffic lights. In contrast, the TLD may not exhibit the same pattern, which may be due to diversity resulting from using different vehicles and camera angles to record videos. The density maps may be normalized to two-dimensional (2D) histograms, where each pixel may represent a normalized frequency of being occupied by a traffic light box throughout an entire dataset. The diversity introduced by using different vehicles for recording may cause a spatial distribution in the two different domains to be different.

FIG. 9 is a diagram of an example 900 associated with identifying relevant traffic lights in driving scenes.

In some implementations, a computing device may determine a location, state, and relevance of each traffic light in a given scene (local prediction) using a single image taken by a camera mounted on a moving vehicle. The computing device may determine whether the vehicle needs to stop at an intersection due to the presence of a relevant red traffic light or whether the vehicle is allowed to proceed (global prediction). Given a strong connection between a global image-level prediction and a local object-level predictions, solving both local and global tasks at the same time may be beneficial. The local and global tasks may be simultaneously solved because “relevant” is an attribute that requires an understanding of a global context, and standard object detectors may fail to fully capture a complexity of the scene or a relationship between objects. The computing device may employ an end-to-end architecture based on deep neural networks, which may include an object detection model for localizing traffic lights and predicting their attributes, and an image classification model, which may take as input both an output of the object detector and features extracted from its backbone, to make predictions on the image.

In some implementations, the end-to-end architecture may be built on top of a standard F aster R-CNN detector, but may be adapted to any detectors that make use of a region-of-interest (Rol) proposal step. A backbone may be instantiated with a convolutional-based network, but may also be used with transformer-based feature extractors. In some implementations, two new classification heads may be added to an output of the standard Faster R-CNN detector to predict a relevance and a state for each traffic light. Additional convolutional blocks attached to a feature space extracted by the backbone may be used to estimate an image-level prediction, while leveraging an output of detection heads.

As shown in FIG. 9, in the end-to-end architecture, images xᵢ may be processed by an enhanced Faster R-CNN detector, which may localize traffic lights in an image while predicting two additional attributes: relevance and state. These detections may enhance extracted feature maps and serve as an input to an image classifier, which may then be used to generate an image-level prediction yᵢ*. The images xᵢ may be processed by the backbone and may be used to form feature maps (fᵢ) and Rol pooling. The feature maps and the Rol pooling may be associated with a region proposal network. Detection heads may depend on the Rol pooling, where the detection heads may include a bounding box regressor, an object classifier, a relevance classifier, and a state classifier. An output of the relevance classifier and the state classifier may be combined with the feature maps to produce enhanced feature maps (fᵢ*). The enhanced feature maps may be fed to convolution layers and a linear classifier, which may then generate the image-level prediction yᵢ*. The relevance classifier and the state classifier, along with an image-level classifier that includes the enhanced features, the convolution layers, and the linear classifier, may be added to the standard Faster R-CNN detector for the specific purpose of handling the local task. The relevance classifier and the state classifier are further described in FIG. 10. The image-level classifier is further described in FIG. 11.

In some implementations, the end-to-end architecture may provide object detection with a prediction of additional attributes. A loss function within the enhanced Faster R-CNN detector may be expressed as a sum of a mean squared error loss for bounding box regression and a cross-entropy loss for object discrimination. For a localization of traffic lights only, an object classification may consider “traffic light” as an only non-background class. To predict the relevance and state attributes, two additional classifiers may be used. These new classifiers, during training, may contribute to an overall loss only when a proposal (anchor) for a traffic light, generated by the region proposal network, matches a ground truth box, mirroring a behavior of a regression loss. A loss Lₐ for an anchor a for an object detection task may be represented by Lₐ=L_{Obj,a} +I_{[a=t]}=I_{[a=t]}(L_{Box,a}+L_{Rel,a}+L_{State,a}), where L_{Obj,a} is a binary cross entropy for object classification. When an anchor a matches some traffic light ground truth t (e.g., when an indicator function I does not vanish), a regression loss L_{Box,a} may be considered for a bounding box, a binary cross entropy L_{Rel,a} for a relevance attribute, and a cross entropy L_{State,a} for a state attribute.

In some implementations, the end-to-end architecture may provide image-level classification. After bounding boxes for each traffic light, along with their respective attributes, are computed, such information may be leveraged to make predictions at an image level. A convolutional encoder may be employed that takes as input the pyramid features extracted by the backbone, enriched by the information computed by the enhanced Faster R-CNN detector.

As indicated above, FIG. 9 is provided as an example. Other examples may differ from what is described with regard to FIG. 9.

FIG. 10 is a diagram of an example 1000 associated with identifying relevant traffic lights in driving scenes.

As shown in FIG. 10, attribute classifiers may be employed for each of T detected instances that are successfully matched with a ground truth in an image. A representation may undergo a scaling-down process and may be augmented with information regarding its position in the image (e.g., predicted localization) before being classified. When such classifiers are implemented, each classifier (e.g., a relevance classifier and a state classifier) may receive as input a feature representation f^{tl} of each individual traffic light. Initially, a linear encoding may be applied to reduce a dimensionality of the feature vector f^{tl}, generating a new representation f^{tl}*. This representation may be enriched by concatenating normalized coordinates of a bounding box predicted by a detector for that specific traffic light (predicted localization), as knowing a precise position of a detected traffic light may aid in refining two attributes associated with relevance and state. The enriched representation may be classified by two linear layers responsible for independently predicting the two attributes.

As indicated above, FIG. 10 is provided as an example. Other examples may differ from what is described with regard to FIG. 10.

FIG. 11 is a diagram of an example 1100 associated with identifying relevant traffic lights in driving scenes.

As shown in FIG. 11, N feature maps, each associated with a pyramid level of decreasing resolution and denoted as fᵢ, may be enriched through an integration of a detection output. Enriching the N feature maps through the integration of the detection output may ensure that a model effectively exploits both localized object information and global context. An output of an object detector may be merged with the N feature maps. A feature map (fᵢ) may be extracted by a backbone, where i∈[1, . . . , N] may denote a level of a feature pyramid and hence a different resolution. Initially, a feature representation may undergo a processing through a 1×1 convolutional block, aiming to reduce a number of channels from c to c′. A resulting output may then be concatenated with c″ new features, computed using an output from the object detector and projected on a feature space. Each new channel may act as a mask, assuming positive values exclusively at locations where a traffic light is detected. In a resulting representation fᵢ*, spatial dimensions may remain hᵢ×wᵢ, as in fᵢ, while a total number of channels becomes c′+c″. Information added from the object detector, through extra channels, may act as useful prior knowledge, which may help the model by giving insights into a presence and characteristics (state and relevance) of traffic lights, and which may improve the model's ability to predict at an image level with more context awareness. During backpropagation, gradients may be prevented from flowing back into detection classifiers. An image-level classifier may operate on a global context and should not influence a local reasoning of detection heads. A refined integration may ensure that the model efficiently uses both local object details and global context for accurate image-level predictions.

As indicated above, FIG. 11 is provided as an example. Other examples may differ from what is described with regard to FIG. 11.

In some implementations, results using a technique for identifying relevant traffic lights in driving scenes using an end-to-end architecture that employs a relevance classifier, a state classifier, and an image-level classifier, as described herein, may be compared with four other approaches on a DTLD and a TLD. The results may be related to a local task of localizing traffic lights and predicting their attributes, as well as a global image-level task. An image classification task may be formulated as a three-class classification problem: relevant red (indicating a need for the vehicle to stop, considering yellow/red lights as relevant for an ego-vehicle), relevant green, and no relevant light (regardless of their state).

In some implementations, regarding an experimental setting and metrics, images with resolutions of 1280×720 and standard data augmentations, such as Gaussian blurring, may be utilized. For the TLD, an original image resolution may be used, and the TLD may be split into training and test sets, while maintaining an 80:20 ratio. For the DTLD, which has a resolution of 2048×1024, two narrow lateral bands of pixels may be removed to match a 16:9 aspect ratio of the TLD before resizing, thus preventing deformation effects. For the DTLD, an official training set may be used during a training phase, and an official validation set may be used as a test set. A backbone of a utilized model may be a type of CNN (e.g., a ResNet50 pre-trained using a common objects in context (COCO) dataset). A specific optimizer (e.g., AdamW) may be used with a specific learning rate (e.g., a learning rate of 0.0001), which may follow an exponential decay policy over time, and a batch size of 8. The model may be trained for 30 epochs on a general processing unit (GPU), and five runs may be conducted with different seeds to ensure that reported results are not affected by random fluctuations.

In some implementations, to evaluate a performance on an object detection task, a COCO average precision (AP_{Obj_50:95}) may be reported for a traffic light class, which may be an integral metric that is computed over multiple thresholds. The same metric may also be used to measure a performance of relevance and state attributes. AP_{Rel_50:95} may be computed with a joint probability of being a traffic light and relevant, while mAP_{State_50:95} may consider all of the possible states independently and may be obtained by averaging results on different classes. For an image classification task, the model's performance may be assessed using an average precision (AP), which may be equivalent to an area under the Precision-Recall curve, for each of three classes. AP^{RR} may be denoted as an AP for the relevant red class, AP^{RG} for the relevant green class, and AP^{NoR} for the no relevant light class. Further, mAP may represent an average AP across all classes.

In some implementations, to assess an effectiveness of the technique for identifying relevant traffic lights in driving scenes using an end-to-end architecture that employs a relevance classifier, a state classifier, and an image-level classifier, as described herein, the technique may be compared against two rule-based approaches and two deep learning models on both the DTLD and the TLD. The two rule-based approaches and the two deep learning models may be used as baselines.

In some implementations, for rule-based approaches, an existence of an oracle may be assumed for traffic light detection and state prediction. The traffic light detection and the state prediction may be used only on the prediction of relevance. A maximum area heuristic may consider a traffic light as relevant when the traffic light has a largest bounding box area among those annotated in an image. The maximum area heuristic may be a first rule-based approach. A score used to evaluate a classification AP metric for this baseline may be an area of a largest bounding box in the image. The larger that a traffic light is, in the image, the more likely the traffic light is to be considered relevant. A top-center distance heuristic may declare that a traffic light is relevant when the traffic light is the one closest to a top-center position of an input image. The top-center distance heuristic may be a second rule-based approach. A score may be computed as an inverse of a distance, meaning that the closer the traffic light is to a top-center point in the image, the more likely the traffic light is considered to be relevant.

In some implementations, regarding deep regression, relevance may be addressed by regressing a point indicating a location in an image where a relevant traffic light should appear. Deep regression may be associated with a first deep learning model. A CNN (e.g., ResNet-50), pre-trained using an ImageNet visual database, may be trained to address a regression task. At inference time, a predicted relevant traffic light may be the one closest to a regressed point in an input image. This regression model may be retrained on both the DTLD and the TLD, while assuming an existence of an oracle for traffic light detection and state prediction. In an AP metric, an inverse of a distance of a bounding box that is closest to a predicted point may be used, which may indicate that a closest traffic light to the regressed point is considered more likely to be relevant.

In some implementations, a F aster R-CNN detector may be adapted to estimate two additional attributes for each detected traffic light. The Faster R-CNN with attributes may be associated with a second deep learning model. Two linear classification heads may be attached to address a binary relevance problem and a 3-class state classification problem, incorporating binary and cross-entropy losses into a total loss, respectively. However, using the Faster R-CNN detector does not involve using predicted localization to enrich a traffic light representation, and the Faster R-CNN detector does not have a final classifier. To generate an image-level prediction, during an inference phase, probabilities of attributes for each traffic light may be considered. A traffic light with a maximum probability of relevance among those detected may be considered, and in order to establish an image-level score, this probability may be multiplied with probabilities of different states.

In some implementations, a performance evaluation of all considered models may be obtained. A traffic light localization and an attribute prediction performance may be measured using a COCO AP. An image-level classification may be measured by an AP on each class, where results may be averaged over five runs. The DTLD may be evaluated using various approaches, such as maximum area, top-center distance, deep regression, and Faster R-CNN with attributes, and then the DTLD may be evaluated using the technique for identifying relevant traffic lights in driving scenes using the end-to-end architecture that employs the relevance classifier, the state classifier, and the image-level classifier. Additionally, the TLD may be evaluated using various approaches, such as maximum area, top-center distance, deep regression, and Faster R-CNN with attributes, and then the TLD may be evaluated using the technique for identifying relevant traffic lights in driving scenes using the end-to-end architecture that employs the relevance classifier, the state classifier, and the image-level classifier. In each case, a traffic light localization (AP_{Obj_50:95}), traffic light attributes (mAP_{State_50:95} and AP_{Rel_50:95}), and image-level classification (AP^{RR}, AP^{RG}, AP^{NoR}, and mAP) may be calculated. Maximum area, top-center distance, and deep regression may use an oracle for traffic light localization and state prediction.

In some implementations, in both datasets (e.g., DTLD and TLD), images with no relevant traffic lights (NoR) may be harder to classify, which may result from an intrinsic difficulty due to an asymmetry in a definition of classes. When giving a correct prediction for relevant red (RR) and relevant green (RG), a model identifying a presence of at least a relevant light with a correct color (not necessarily a correct color) may be sufficient. For the “no relevant” class, the model may need to correctly understand that not all traffic lights in an image are relevant. In DTLD, a NoR class may appear even harder, which may be due to a more extreme class imbalance.

In some implementations, for the first three baselines (e.g., maximum area, top-center distance, and deep regression), which may use information from an oracle, even with perfect knowledge of traffic light positions and states, inferring which traffic lights are relevant for an ego-vehicle may not be a trivial task. Maximum area may emerge as a least effective heuristic, although maximum area may perform better in DTLD (with mAP 40 and 63, respectively). In the DTLD, the relevant traffic lights may be typically larger than not relevant traffic lights, where such a clear difference may not exist in the TLD. Both top-center distance and deep regression may exhibit similar performance across both domains, showing that a position of the traffic light within the image may be an important feature to predict its relevance.

In some implementations, in an end-to-end approach that involves the Faster R-CNN, such an approach may achieve good performance across all classes in both datasets, but may still be outperformed by the technique for identifying relevant traffic lights in driving scenes using the end-to-end architecture that employs the relevance classifier, the state classifier, and the image-level classifier. Results may show that addressing local and global tasks in a combined manner may improve object-level predictions (significant on all attributes in both datasets) and global image-level classification (+6.8 of mAP over a best baseline on the TLD), which may indicate that the model correctly integrates local information on the traffic lights at a global image level. The technique for identifying relevant traffic lights in driving scenes using the end-to-end architecture that employs the relevance classifier, the state classifier, and the image-level classifier may analyze all detected traffic lights and minimize errors by considering more than just a highest relevant score, as done in all of the other baselines. Considering more than just the highest relevant score may be important when an object detector struggles to properly identify the relevant traffic lights, where such a scenario may occur when traffic lights are relatively close together or located at mid to long distances from the ego-vehicle.

As an example, in an image, a prediction may be performed, where the prediction may involve a ground truth (e.g., relevant green) and an image-level prediction (relevant green). The prediction may show a relevance score for each detected traffic light, while colors may represent a predicted state. In this example, an object detection may fail to assign a highest score to a correct signal. However, an image-level classifier may correctly classify the image as “relevant green”. Thus, the image-level classifier may overrule a local decision reasoning at a global level and exploit all detection outputs.

In some implementations, additional experiments may be performed to empirically quantify a domain gap between the TLD and the DTLD. The additional experiments may involve training a model on one dataset and then testing the model on another dataset. Based on the additional experiments, models trained on one dataset may transfer poorly to the other dataset. For example, a model trained on the DTLD may perform poorly on the TLD, and vice versa. This empirical study may emphasize inherent differences between the two datasets. Additionally, generalizing a localization task to a target domain may be more challenging as compared to image classification. To better understand a gap in traffic light localization, a COCO AP^{Obj} may be analyzed at two specific thresholds, namely 50 and 75. Specifically, at AP_{Obj_50}, a transfer from the TLD to the DTLD may show notably better results as compared to a reverse transfer. However, when the thresholds are adjusted, a performance may degrade rapidly, bringing the transfer in both directions into closer alignment.

In some implementations, various design choices may be evaluated or assessed, such as an impact of incorporating box localization within attribute heads and integrating an image classifier on top of a detection task. Performance metrics for both the attributes and the image-level task may be obtained under various conditions. Such conditions may include when both box localization and the image classifier are deactivated (e.g., the Faster R-CNN with attributes), when either the box localization or the image classifier are activated, and when both the box localization and the image classifier are activated. Removing the image classifier may cause a considerable drop in a global prediction performance, with a mean average precision (mAP) dropping by 5.8 points (from 91.3 to 85.5). Conversely, deactivating the box localization may lead to a decrease in an ability to predict the relevance attribute, reducing the APRel 50:95 by 1 point (from 26.6 to 25.6). The localization information may slightly improve the relevance prediction. When both components are active, a performance in each task may achieve its peak values, confirming that the benefits offered by these two additions may be exploited.

In some implementations, a deeper analysis may be conducted on an image classification module presenting a performance achieved by making a classification on a feature space, e.g., deactivating both the convolutional blocks and detection priors, activating only the convolutional blocks, and activating both the convolution blocks and the detection priors. An ablation study on components of the image-level classifier may indicate that adding a simple linear classifier on the feature space generated by a backbone, rather than relying solely on attributes, may enhance the mAP of a global task by approximately 3 points. Enriching the features with detection priors and processing the features with a convolutional block may result in an additional improvement of 3 points in total. Adding a linear classifier on the feature space may improve performance by approximately 3 points, while both the convolutional block and the detection priors may each contribute an improvement of 1.5 points.

In some implementations, in a scenario in which both the convolutional layers and the detection priors are enabled, a parameter c′ may be validated, where the parameter c′ may represent a depth of a feature maps before incorporating information from a detection task. A substantial reduction in a number of output channels may lead to a loss of information, while retaining an excessive number of channels may inhibit an effective utilization of detection information, which may result in a degradation of performance. In an ablation study on the parameter c′, which may denote a number of output channels of a 1×1 convolutional layer before a fusion of pyramid feature maps and detection output, a small number of channels may result in the loss of information, while a large number may hinder an effective utilization of the detection information. By averaging the results of 5 runs, an optimal value for the parameter c′, indicated by a peak value of the mAP, may be approximately 64.

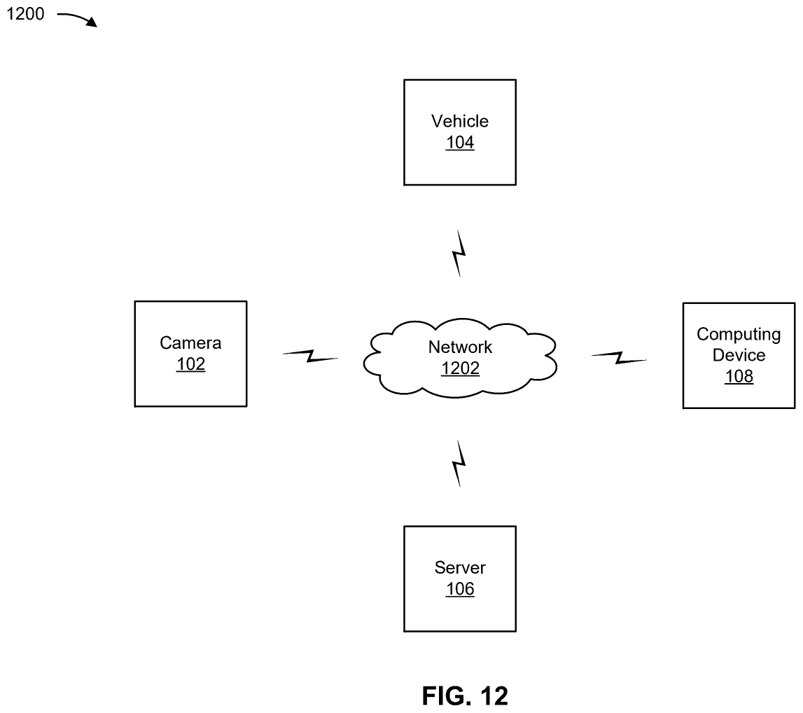

FIG. 12 is a diagram of an example environment 1200 in which systems and/or methods described herein may be implemented. As shown in FIG. 12, environment 1200 may include a camera 102, a vehicle 104, a server 106, a computing device 108, and a network 1202. Devices of environment 1200 may interconnect via wired connections, wireless connections, or a combination of wired and wireless connections.

In some implementations, the camera 102 may be onboard the vehicle 104. For example, the camera 102 may be installed on a dashboard of the vehicle 104. The camera 102 may be able to record video of a scene in front of the vehicle. For example, the camera 102 may be able to record objects and pedestrians that are in front of the vehicle.

The server 106 may include one or more devices capable of receiving, generating, storing, processing, providing, and/or routing information associated with detecting traffic light violations, as described elsewhere herein. The server 106 may include one or more devices capable of receiving, generating, storing, processing, providing, and/or routing information associated with identifying relevant traffic lights in driving scenes, as described elsewhere herein. The server 106 may include a communication device and/or a computing device. For example, the server 106 may include a server, such as an application server, a client server, a web server, a database server, a host server, a proxy server, a virtual server (e.g., executing on computing hardware), or a server in a cloud computing system. In some implementations, the server 106 may include computing hardware used in a cloud computing environment.

The computing device 108 may include one or more devices capable of receiving, generating, storing, processing, and/or providing information associated with detecting traffic light violations, as described elsewhere herein. The computing device 108 may include one or more devices capable of receiving, generating, storing, processing, providing, and/or routing information associated with identifying relevant traffic lights in driving scenes, as described elsewhere herein. The computing device 108 may include a communication device and/or a computing device. For example, the computing device 108 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 1202 may include one or more wired and/or wireless networks. For example, the network 1202 may include a cellular network (e.g., a Fifth Generation (5G) network, a Fourth Generation (4G) network, a long-term evolution (LTE) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 1202 enables communication among the devices of environment 1200.

The number and arrangement of devices and networks shown in FIG. 12 are provided as an example. In practice, there may be additional devices and/or networks, fewer devices and/or networks, different devices and/or networks, or differently arranged devices and/or networks than those shown in FIG. 12. Furthermore, two or more devices shown in FIG. 12 may be implemented within a single device, or a single device shown in FIG. 12 may be implemented as multiple, distributed devices. Additionally, or alternatively, a set of devices (e.g., one or more devices) of environment 1200 may perform one or more functions described as being performed by another set of devices of environment 1200.

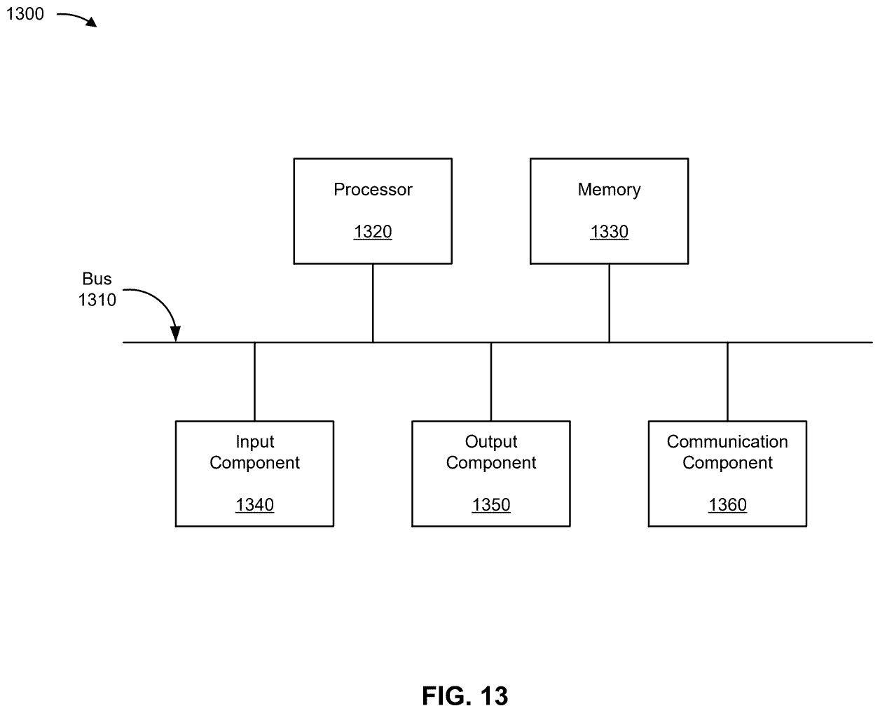

FIG. 13 is a diagram of example components of a device 1300 associated with detecting traffic light violations and/or identifying relevant traffic lights in driving scenes. The device 1300 may correspond to a server (e.g., server 106). In some implementations, the server may include one or more devices 1300 and/or one or more components of the device 1300. As shown in FIG. 13, the device 1300 may include a bus 1310, a processor 1320, a memory 1330, an input component 1340, an output component 1350, and/or a communication component 1360.

The bus 1310 may include one or more components that enable wired and/or wireless communication among the components of the device 1300. The bus 1310 may couple together two or more components of FIG. 13, such as via operative coupling, communicative coupling, electronic coupling, and/or electric coupling. For example, the bus 1310 may include an electrical connection (e.g., a wire, a trace, and/or a lead) and/or a wireless bus. The processor 1320 may include a central processing unit, a graphics processing unit, a microprocessor, a controller, a microcontroller, a digital signal processor, a field-programmable gate array, an application-specific integrated circuit, and/or another type of processing component. The processor 1320 may be implemented in hardware, firmware, or a combination of hardware and software. In some implementations, the processor 1320 may include one or more processors capable of being programmed to perform one or more operations or processes described elsewhere herein.

The memory 1330 may include volatile and/or nonvolatile memory. For example, the memory 1330 may include random access memory (RAM), read only memory (ROM), a hard disk drive, and/or another type of memory (e.g., a flash memory, a magnetic memory, and/or an optical memory). The memory 1330 may include internal memory (e.g., RAM, ROM, or a hard disk drive) and/or removable memory (e.g., removable via a universal serial bus connection). The memory 1330 may be a non-transitory computer-readable medium. The memory 1330 may store information, one or more instructions, and/or software (e.g., one or more software applications) related to the operation of the device 1300. In some implementations, the memory 1330 may include one or more memories that are coupled (e.g., communicatively coupled) to one or more processors (e.g., processor 1320), such as via the bus 1310. Communicative coupling between a processor 1320 and a memory 1330 may enable the processor 1320 to read and/or process information stored in the memory 1330 and/or to store information in the memory 1330.

The input component 1340 may enable the device 1300 to receive input, such as user input and/or sensed input. For example, the input component 1340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 1350 may enable the device 1300 to provide output, such as via a display, a speaker, and/or a light-emitting diode. The communication component 1360 may enable the device 1300 to communicate with other devices via a wired connection and/or a wireless connection. For example, the communication component 1360 may include a receiver, a transmitter, a transceiver, a modem, a network interface card, and/or an antenna.

The device 1300 may perform one or more operations or processes described herein. For example, a non-transitory computer-readable medium (e.g., memory 1330) may store a set of instructions (e.g., one or more instructions or code) for execution by the processor 1320. The processor 1320 may execute the set of instructions to perform one or more operations or processes described herein. In some implementations, execution of the set of instructions, by one or more processors 1320, causes the one or more processors 1320 and/or the device 1300 to perform one or more operations or processes described herein. In some implementations, hardwired circuitry may be used instead of or in combination with the instructions to perform one or more operations or processes described herein. Additionally, or alternatively, the processor 1320 may be configured to perform one or more operations or processes described herein. Thus, implementations described herein are not limited to any specific combination of hardware circuitry and software.

The number and arrangement of components shown in FIG. 13 are provided as an example. The device 1300 may include additional components, fewer components, different components, or differently arranged components than those shown in FIG. 13. Additionally, or alternatively, a set of components (e.g., one or more components) of the device 1300 may perform one or more functions described as being performed by another set of components of the device 1300.

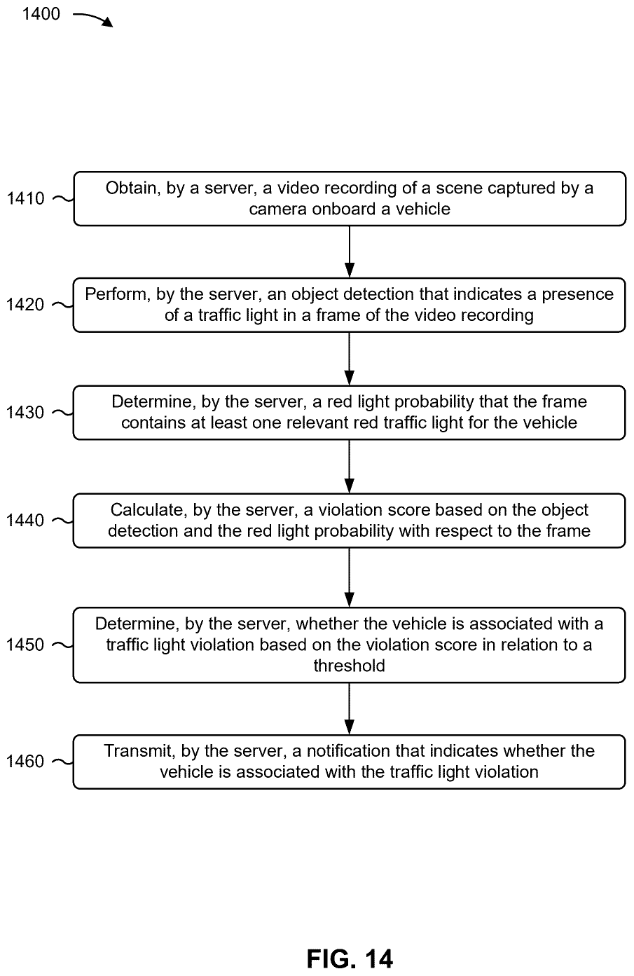

FIG. 14 is a flowchart of an example process 1400 associated with detecting traffic light violations. In some implementations, one or more process blocks of FIG. 14 may be performed by a server (e.g., server 106). In some implementations, one or more process blocks of FIG. 14 may be performed by another device or a group of devices separate from or including the server. Additionally, or alternatively, one or more process blocks of FIG. 14 may be performed by one or more components of device 1300, such as processor 1320, memory 1330, input component 1340, output component 1350, and/or communication component 1360.

As shown in FIG. 14, process 1400 may include obtaining, by the server, a video recording of a scene captured by a camera onboard a vehicle (block 1410). The camera may capture the scene, and then the camera may upload the video recording to the server. The camera may be a dashboard camera installed on a dashboard of the vehicle. The camera may continuously record video when the vehicle is turned on.

In some implementations, the server may obtain sensor information associated with the vehicle. The sensor information may include rotation information, which may be obtained from a gyroscope associated with the camera and/or the vehicle. The sensor information may include speed information, which may be obtained from a GPS associated with the vehicle. The server may perform, by the server and based on the sensor information, a turn detection that indicates whether the vehicle is performing a turn. The turn detection may be based on the rotation information. In other words, a certain value in the rotation information may indicate whether or not the vehicle is turning in a particular direction (e.g., turning right).

As shown in FIG. 14, process 1400 may include performing, by the server, an object detection that indicates a presence of a traffic light in a frame of the video recording (block 1420). The object detection may be used to determine whether the frame shows the traffic light, and if so, a color associated with the traffic light (e.g., red, yellow, or green).

As shown in FIG. 14, process 1400 may include determining, by the server, a red light probability that the frame contains at least one relevant red traffic light for the vehicle (block 1430). In some cases, the server may determine the red light probability using an image classifier. The image classifier may be used to categorize road images captured by the camera. The image classifier may be based on an object detector with multiple attributes, and the multiple attributes may include a first attribute for traffic light relevance and a second attribute for traffic light state. In some implementations, the vehicle may receive, from a device associated with a smart city technology, an indication of a relevant traffic light state. In this example, the server may determine the relevant traffic light state based on the received indication.

As shown in FIG. 14, process 1400 may include calculating, by the server, a violation score based on the object detection and the red light probability with respect to the frame (block 1440). In some cases, the violation score may also be based on the turn detection. The violation score may account for, based on a grace period, a traffic light that turns green for a limited time period that allows only a single vehicle to pass and then turns red. The violation score may account for the vehicle making a lawfully permitted right turn when the traffic light is red. The violation score may account for the traffic light flashing red or flashing yellow. In some cases, the vehicle may calculate the violation score based on the relevant traffic light state.

As shown in FIG. 14, process 1400 may include determining, by the server, whether the vehicle is associated with a traffic light violation based on the violation score in relation to a threshold (block 1450). The traffic light violation may involve the vehicle driving past an intersection when the traffic light is red, and no exception exists that lawfully permits the vehicle to cross the intersection when the traffic light is red. A detection of the traffic light violation may be based on video information, speed information, and heuristics, and the detection of the traffic light violation may be without a use of satellite map information.

As shown in FIG. 14, process 1400 may include transmitting, by the server, a notification that indicates whether the vehicle is associated with the traffic light violation (block 1460). The notification may indicate a recommendation for a driver of the vehicle to improve a driving behavior and increase safety in response to the traffic light violation.

In some implementations, the server may determine a not relevant probability that the frame contains no traffic light or that the frame contains one or more traffic lights that are not relevant to the vehicle. The server may perform, based on the sensor information, a speed detection that indicates a speed associated with the vehicle during the frame. The server may calculate the violation score based on the not relevant probability and the speed detection.

In some implementations, the server may determine a green light probability that the frame contains at least one relevant green traffic light for the vehicle. The server may calculate the violation score based on the green light probability. In some cases, the server may determine the not relevant probability and/or the green light probability using the image classifier.

In some implementations, server may determine, based on the image classifier, a yellow light probability that the frame contains at least one relevant yellow traffic light for the vehicle. The server may determine the not relevant probability that the frame contains no traffic light or that the frame contains one or more traffic lights that are not relevant to the vehicle. The server may perform, based on the sensor information, a speed detection that indicates a speed associated with the vehicle during the frame. The server may determine a yellow stop score that indicates a severity of a yellow light violation, where the yellow stop score may be based on the speed and a duration of a detected yellow relevant traffic light. The server may calculate the violation score based on the object detection, the turn detection, the yellow light probability, the not relevant probability, the speed detection, and the yellow stop score.

Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

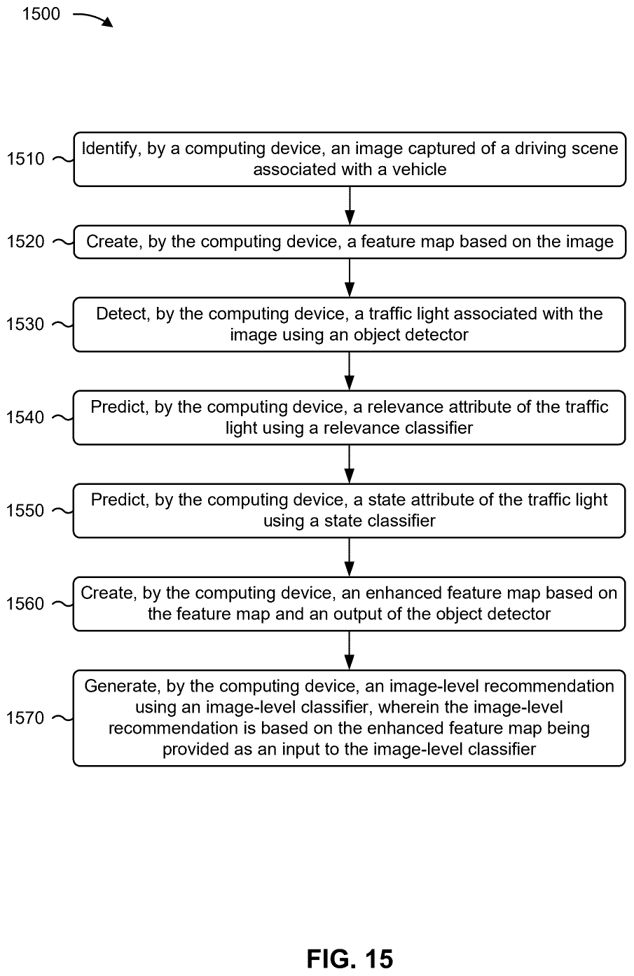

FIG. 15 is a flowchart of an example process 1500 associated with identifying relevant traffic lights in driving scenes. In some implementations, one or more process blocks of FIG. 15 may be performed by a computing device (e.g., computing device 108). In some implementations, one or more process blocks of FIG. 15 may be performed by another device or a group of devices separate from or including the computing device. Additionally, or alternatively, one or more process blocks of FIG. 15 may be performed by one or more components of device 1300, such as processor 1320, memory 1330, input component 1340, output component 1350, and/or communication component 1360.

As shown in FIG. 15, process 1500 may include identifying, by the computing device, an image captured of a driving scene associated with a vehicle (block 1510). A camera associated with the vehicle may capture the image of the driving scene (e.g., a scene toward a front of the vehicle, a back of the vehicle, and/or a side of the vehicle). The computing device may receive the image from the camera.

As shown in FIG. 15, process 1500 may include creating, by the computing device, a feature map based on the image (block 1520). The feature map may represent specific features of the image, where the image may be inputted to a convolutional layer. An output of the convolutional layer may be the feature map. The feature map may indicate low-level features associated with the image, such as edges, corners, and/or basic shapes. The feature map may represent a response of a particular filter applied to the image. Additional feature maps may be created, which may represent higher-level features, such as shapes, textures, and/or object parts.

As shown in FIG. 15, process 1500 may include detecting, by the computing device, a traffic light associated with the image using an object detector (block 1530). The computing device may detect, using the object detector (or object classifier), the traffic light based on the feature map. The object detector may be capable of object detection, where the object detection may be based on the feature map. In some cases, the traffic light may be one of a plurality of traffic lights associated with the image, but not all traffic lights may be relevant to the vehicle.

As shown in FIG. 15, process 1500 may include predicting, by the computing device, a relevance attribute of the traffic light using a relevance classifier (block 1540). The computing device may determine the relevance attribute in accordance with a local task. A predicted relevance of the traffic light may indicate whether the traffic light is relevant to the vehicle. For example, the predicted relevance may be a score that indicates whether or not the traffic light is relevant to the vehicle. The computing device may use the relevance classifier, which uses the feature map as an input, to predict the relevance attribute. In some implementations, the computing device may identify a feature representation of the traffic light. The computing device may modify the feature representation based on a concatenation of normalized coordinates of a predicted bounding box for the traffic light, to obtain a resulting output. The computing device may provide the resulting output as an input to the relevance classifier.

As shown in FIG. 15, process 1500 may include predicting, by the computing device, a state attribute of the traffic light using a state classifier (block 1550). The computing device may determine the state attribute in accordance with the local task. A predicted state of the traffic light may indicate a color associated with the traffic light. For example, the predicted state may be a green traffic light, a yellow traffic light, or a red traffic light. The computing device may use the state classifier, which uses the feature map as the input, to predict the state attribute. In some implementations, the computing device may identify the feature representation of the traffic light. The computing device may modify the feature representation based on the concatenation of normalized coordinates of the predicted bounding box for the traffic light, to obtain the resulting output. The computing device may provide the resulting output as an input to the state classifier.

As shown in FIG. 15, process 1500 may include creating, by the computing device, an enhanced feature map based on the feature map and an output of the object detector (block 1560). The enhanced feature map may be created based on the feature map, a predicted bounding box (e.g., a computed bounding box of the traffic light), a predicted relevance attribute (e.g., the relevance attribute of the traffic light), and/or a predicted state (e.g., the state attribute of the traffic light).

As shown in FIG. 15, process 1500 may include generating, by the computing device, an image-level recommendation using an image-level classifier, wherein the image-level recommendation is based on the enhanced feature map being provided as an input to the image-level classifier (block 1570). The computing device may determine the image-level recommendation, in conjunction with the relevance attribute and the state attribute, in accordance with a global task. The image-level recommendation may indicate that the vehicle is to stop when a relevant traffic light is red or yellow. Alternatively, the image-level recommendation may indicate that the vehicle is not required to stop when the relevant traffic light is green. In some implementations, the computing device may generate the image-level recommendation based on a convolutional encoder. The convolutional encoder may receive, as an input, the enhanced feature map, and the convolutional encoder may determine the image-level recommendation based on the enhanced feature map.

In some implementations, the computing device may use a R-CNN based detector, such as a Faster R-CNN detector, to identify a relevant traffic light in the image and provide the image-level recommendation. The Faster R-CNN detector may use an end-to-end architecture that employs the relevance classifier, the state classifier, and the image-level classifier, which may provide, as an output, the image-level recommendation (or image-level prediction). The computing device may identify the relevant traffic light in the image without using a positioning system or an HD map. In some implementations, the computing device may identify a risky driving behavior based on the image-level recommendation. The computing device may provide a notification based on the risky driving behavior, wherein the notification indicates a recommended driving practice in view of the risky driving behavior.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a computing device, an image captured of a driving scene associated with a vehicle;
creating, by the computing device, a feature map based on the image;
detecting, by the computing device, a traffic light associated with the image using an object detector;
predicting, by the computing device, a relevance attribute of the traffic light using a relevance classifier;
predicting, by the computing device, a state attribute of the traffic light using a state classifier;
creating, by the computing device, an enhanced feature map based on the feature map and an output of the object detector; and
generating, by the computing device, an image-level recommendation using an image-level classifier, wherein the image-level recommendation is based on the enhanced feature map being provided as an input to the image-level classifier.

2. The method of claim 1, further comprising:
determining, by the computing device, the relevance attribute and the state attribute in accordance with a local task; and
determining, by the computing device, the image-level recommendation, in conjunction with the relevance attribute and the state attribute, in accordance with a global task.

3. The method of claim 1, wherein the image-level recommendation indicates that the vehicle is to stop when a relevant traffic light is red.

4. The method of claim 1, further comprising:
identifying a feature representation of the traffic light;
modifying the feature representation based on a concatenation of normalized coordinates of a predicted bounding box for the traffic light, to obtain a resulting output; and
providing the resulting output as an input to the relevance classifier and the state classifier.

5. The method of claim 1, wherein generating the image-level recommendation is based on a convolutional encoder, wherein the convolutional encoder receives, as an input, the enhanced feature map, and wherein the enhanced feature map is based on the feature map, the relevance attribute of the traffic light, the state attribute of the traffic light, and a computed bounding box of the traffic light.

6. The method of claim 1, further comprising:
using, by the computing device, a region-based convolutional neural network (R-CNN) detector to identify a relevant traffic light in the image and provide the image-level recommendation.

7. The method of claim 1, further comprising:
identifying, by the computing device, a risky driving behavior based on the image-level recommendation; and
providing, by the computing device, a notification based on the risky driving behavior, wherein the notification indicates a recommended driving practice in view of the risky driving behavior.

8. The method of claim 1, further comprising:
identifying, by the computing device, a relevant traffic light in the image without using a positioning system or a high-definition map.

9. A computing device, comprising:
one or more processors configured to:
identify an image captured of a driving scene associated with a vehicle;
create a feature map based on the image;
detect a traffic light associated with the image using an object detector;
predict a relevance attribute of the traffic light using a relevance classifier;
predict a state attribute of the traffic light using a state classifier;
create an enhanced feature map based on the feature map and an output of the object detector; and
generate an image-level recommendation using an image-level classifier, wherein the image-level recommendation is based on the enhanced feature map being provided as an input to the image-level classifier.

10. The computing device of claim 9, wherein the one or more processors are configured to:
determine the relevance attribute and the state attribute in accordance with a local task; and
determine the image-level recommendation, in conjunction with the relevance attribute and the state attribute, in accordance with a global task.

11. The computing device of claim 9, wherein the image-level recommendation indicates that the vehicle is to stop when a relevant traffic light is red.

12. The computing device of claim 9, wherein the one or more processors are configured to:
identify a feature representation of the traffic light;
modify the feature representation based on a concatenation of normalized coordinates of a predicted bounding box for the traffic light, to obtain a resulting output; and
provide the resulting output as an input to the relevance classifier and the state classifier.

13. The computing device of claim 9, wherein the one or more processors are configured to:
generate the image-level recommendation based on a convolutional encoder, wherein the convolutional encoder is configured to receive, as an input, the enhanced feature map, and wherein the enhanced feature map is based on the feature map, the relevance attribute of the traffic light, the state attribute of the traffic light, and a computed bounding box of the traffic light.

14. The computing device of claim 9, wherein the one or more processors are configured to:
use a region-based convolutional neural network (R-CNN) detector to identify a relevant traffic light in the image and provide the image-level recommendation.

15. The computing device of claim 9, wherein the one or more processors are configured to:
identify a risky driving behavior based on the image-level recommendation; and
provide a notification based on the risky driving behavior, wherein the notification indicates a recommended driving practice in view of the risky driving behavior.

16. The computing device of claim 9, wherein the one or more processors are configured to:
identify a relevant traffic light in the image without using a positioning system or a high-definition map.

17. A non-transitory computer-readable medium storing a set of instructions, the set of instructions comprising:
one or more instructions that, when executed by one or more processors of a computing device, cause the computing device to:
identify an image captured of a driving scene associated with a vehicle;
create a feature map based on the image;
detect a traffic light associated with the image using an object detector;
predict a relevance attribute of the traffic light using a relevance classifier;
predict a state attribute of the traffic light using a state classifier;
create an enhanced feature map based on the feature map and an output of the object detector; and
generate an image-level recommendation using an image-level classifier, wherein the image-level recommendation is based on the enhanced feature map being provided as an input to the image-level classifier.

18. The non-transitory computer-readable medium of claim 17, wherein the one or more instructions, when executed by the one or more processors, further cause the computing device to:
determine the relevance attribute and the state attribute in accordance with a local task; and
determine the image-level recommendation, in conjunction with the relevance attribute and the state attribute, in accordance with a global task.

19. The non-transitory computer-readable medium of claim 17, wherein the one or more instructions, when executed by the one or more processors, further cause the computing device to:
identify a feature representation of the traffic light;
modify the feature representation based on a concatenation of normalized coordinates of a predicted bounding box for the traffic light, to obtain a resulting output; and
provide the resulting output as an input to the relevance classifier and the state classifier.

20. The non-transitory computer-readable medium of claim 17, wherein the one or more instructions, when executed by the one or more processors, further cause the computing device to:
generate the image-level recommendation based on a convolutional encoder, wherein the convolutional encoder is configured to receive, as an input, the enhanced feature map, and wherein the enhanced feature map is based on the feature map, the relevance attribute of the traffic light, the state attribute of the traffic light, and a computed bounding box of the traffic light.
